(19) United States
(12) Patent Application Publication
(10) Pub. No.: US 2024/0198282 A1
(43) Pub. Date: Jun. 20, 2024

(54) TUNABLE H2S AND CO2 CONDENSABILITY MEMBRANES FOR H2S AND CO2 REMOVAL FROM SOUR NATURAL GAS

(71) Applicant: Saudi Arabian Oil Company, Dhahran (SA)

(72) Inventors: Yang Liu, Belmont, MA (US); Junyan Yang, Acton, MA (US); Milind M. Vaidya, Dhahran (SA)

(21) Appl. No.: 18/082,994

(22) Filed: Dec. 16, 2022

(51) Int. Cl. B01D 53/22; B01D 69/02; B01D 71/64; C10L 3/10

(52) U.S. Cl. CPC B01D 53/228; B01D 69/02; B01D 71/64; C10L 3/103; C10L 3/104; B01D 2325/20; C10L 2290/548

(57) ABSTRACT

This disclosure relates to polymer membranes and methods of using said membranes for gas separation applications, such as removal of hydrogen sulfide (H₂S) and carbon dioxide (CO₂) from natural gas, particularly under rich natural gas and/or high pressure environments.

### TECHNICAL FIELD

This document relates to polymer membranes. This document also relates to methods of using said membranes for the removal of hydrogen sulfide (H₂S) and carbon dioxide (CO₂) from natural gas, particularly under rich natural gas and/or high pressure environments.

### BACKGROUND

Natural gas supplies over 20% of the energy used worldwide and makes up nearly a quarter of electricity generation, and also plays a crucial role as a feedstock for industry. Raw natural gas typically contains about 50-90% methane (CH₄) as the primary component, with the remaining components being heavier hydrocarbons and undesired impurities. Among the various impurities that must be removed before the sale and use of natural gas, acidic components, such as hydrogen sulfide (H₂S) and carbon dioxide (CO₂), are removed with higher priority due to their corrosive nature. For example, for transportation and use in the United States, the concentration of H₂S must be less than 4 part per million (ppm) and the concentration of CO₂ must be less 2% in a pipeline. As such, both H₂S and CO₂ must be removed from the raw gas to produce clean and commercially viable product. The bulk removal of these gases is referred to as “natural gas sweetening.”

A widely applied technology used for the removal of acid gas from gas mixtures is amine absorption. However, this process is highly energy intensive due to the significant amount of energy needed for regenerating the amine solvent for reuse, which accounts for up to 80% of the total energy cost in the process. Moreover, such a process also consumes a significant amount of water. Furthermore, amine tends to degrade after a number of runs.

Another technology that has gained greater industrial application is the use of polymeric membrane-based technology for gas separation applications, such as natural gas sweetening, oxygen enrichment, hydrogen purification, and nitrogen and organic compounds removal from natural gas. Though this technology has high energy efficiency, a small footprint (ease of processability into different configurations), and low capital cost, there exists a trade-off behavior between productivity (permeability) and efficiency (selectivity). Polyimide membranes, such as those that contain glassy polymeric materials such as 6FDA, constitute a large portion of the membrane market in gas separation. However, industrial applications of polyimide membranes are still limited for bulk removal of aggressive acid gases from natural gas due to their low permeability and high CO₂ plasticization.

Therefore, there is a need for new polymer membranes for removing CO₂ and H₂S from natural gas that can be used under industrial conditions, actual field environments, and testing conditions, that exhibit a combination of high permeability and high selectivity.

### SUMMARY

Provided in the present disclosure are polymer membranes, as well as methods of preparing the polymer membranes and methods of using the polymer membranes for gas separation applications, such as the removal of hydrogen sulfide (H₂S) and carbon dioxide (CO₂) from natural gas, particularly under rich natural gas and/or high pressure environments.

Thus, provided in the present disclosure are methods of separating carbon dioxide (CO₂) and hydrogen sulfide (H₂S) from natural gas, including providing a polymer membrane including a polymer selected from 6FDA-DAM/DABA (3:1) and 6FDA-DAM/DABA (5:1); introducing a natural gas stream to the polymer membrane, where the natural gas stream includes CO₂, H₂S, and methane (CH₄), and the natural gas stream includes at least about 5% H₂S by volume; and removing carbon dioxide (CO₂) and hydrogen sulfide (H₂S) from the natural gas.

In some embodiments, the natural gas stream includes about 5% to about 30% H₂S by volume, about 5% to about 25% H₂S by volume, about 5% to about 20% H₂S by volume, about 5% to about 18% H₂S by volume, about 5% to about 16% H₂S by volume, about 5% to about 14% H₂S by volume, about 5% to about 12% H₂S by volume, about 5% to about 10% H₂S by volume, about 10% to about 20% H₂S by volume, about 12% to about 20% H₂S by volume, about 14% to about 20% H₂S by volume, about 16% to about 20% H₂S by volume, about 18% to about 20% H₂S by volume, or about 18% to about 22% H₂S by volume. In some embodiments, the natural gas stream includes about 20% or more H₂S by volume. In some embodiments, the natural gas stream includes about 5% to about 20% H₂S and about 3% to about 15% CO₂ by volume.

In some embodiments, the natural gas stream further includes ethane (C₂H₆), ethylene (C₂H₄), C₃₊ hydrocarbons, nitrogen (N₂), water (H₂O), and combinations thereof.

In some embodiments, the natural gas stream has a pressure of at least about 800 psig.

In some embodiments, the polymer membrane is thermally treated.

In some embodiments, (i) the H₂S has a permeability of about 85 to about 135 Barrer; (ii) the H₂S/CH₄ selectivity is about 15 to about 27; (iii) the CO₂ has a permeability of about 120 to about 200 Barrer; and/or (iv) the CO₂/CH₄ selectivity is about 24 to about 36.

In some embodiments, the polymer membrane exhibits (i) an H₂S permeability increase of about 140% to about 310%; (ii) an H₂S/CH₄ selectivity increase of about 10% to about 35%; and/or (iii) a CO₂ permeability increase of about 30% to about 230%; as compared to the same polymer membrane including 6FDA-DAM/DABA (3:2) polymer.

In some embodiments, (i) the H₂S has a permeability of about 75 to about 550 Barrer; (ii) the H₂S/CH₄ selectivity is about 20 to about 35; (iii) the CO₂ has a permeability is about 120 to about 300 Barrer; and/or (iv) the CO₂/CH₄ selectivity is about 15 to about 40; where the natural gas stream includes at least about 20% H₂S by volume.

In some embodiments, the natural gas stream includes at least about 20% H₂S by volume and the polymer membrane exhibits (i) an H₂S permeability increase of about 65% to about 320%; and/or (ii) a CO₂ permeability increase of about 150% to about 270%; as compared to the same polymer membrane including 6FDA-DAM/DABA (3:2) polymer.

In some embodiments, the natural gas stream includes at least about 20% H₂S by volume and the polymer membrane exhibits (i) an H₂S/CH₄ selectivity increase of about 1% to about 15%; and/or (ii) a CO₂/CH₄ selectivity increase of about 40% to about 60%; as compared to the same polymer membrane including 6FDA-DAM polymer.

Also provided in the present disclosure are methods of separating carbon dioxide (CO₂) and hydrogen sulfide (H₂S) from natural gas, including providing a polymer membrane including a polymer selected from 6FDA-DAM/DABA (3:1) and 6FDA-DAM/DABA (5:1); introducing a natural gas stream to the polymer membrane, where the natural gas stream has a pressure of at least 500 psig; and removing carbon dioxide (CO₂) and hydrogen sulfide (H₂S) from the natural gas.

In some embodiments, the natural gas stream has a pressure of about 500 psig to about 1100 psig, about 600 psig to about 1000 psig, about 700 psig to about 900 psig, or about 750 psig to about 850 psig. In some embodiments, the natural gas stream has a pressure of at least about 800 psig.

In some embodiments, the natural gas stream includes about 5% to about 30% H₂S by volume, about 5% to about 25% H₂S by volume, about 5% to about 20% H₂S by volume, about 5% to about 18% H₂S by volume, about 5% to about 16% H₂S by volume, about 5% to about 14% H₂S by volume, about 5% to about 12% H₂S by volume, about 5% to about 10% H₂S by volume, about 10% to about 20% H₂S by volume, about 12% to about 20% H₂S by volume, about 14% to about 20% H₂S by volume, about 16% to about 20% H₂S by volume, about 18% to about 20% H₂S by volume, or about 18% to about 22% H₂S by volume. In some embodiments, the natural gas stream includes about 20% or more H₂S by volume. In some embodiments, the natural gas stream includes about 5% to about 20% H₂S and about 3% to about 15% CO₂ by volume.

In some embodiments, the natural gas stream further includes ethane (C₂H₆), ethylene (C₂H₄), C₃₊ hydrocarbons, nitrogen (N₂), water (H₂O), and combinations thereof.

In some embodiments, the polymer membrane is thermally treated.

In some embodiments, (i) the H₂S has a permeability of about 85 to about 135 Barrer; (ii) the H₂S/CH₄ selectivity is about 15 to about 27; (iii) the CO₂ has a permeability of about 120 to about 200 Barrer; and/or (iv) the CO₂/CH₄ selectivity is about 24 to about 36.

In some embodiments, the polymer membrane exhibits (i) an H₂S permeability increase of about 140% to about 310%; (ii) an H₂S/CH₄ selectivity increase of about 10% to about 35%; and/or (iii) a CO₂ permeability increase of about 30% to about 230%; as compared to the same polymer membrane including 6FDA-DAM/DABA (3:2) polymer.

In some embodiments, (i) the H₂S has a permeability of about 75 to about 550 Barrer; (ii) the H₂S/CH₄ selectivity is about 20 to about 35; (iii) the CO₂ has a permeability is about 120 to about 300 Barrer; and/or (iv) the CO₂/CH₄ selectivity is about 15 to about 40; where the natural gas stream has a pressure of at least 500 psig.

In some embodiments, the natural gas stream has a pressure of at least 500 psig and the polymer membrane exhibits (i) an H₂S permeability increase of about 65% to about 320%; and/or (ii) a CO₂ permeability increase of about 150% to about 270%; as compared to the same polymer membrane including 6FDA-DAM/DABA (3:2) polymer.

In some embodiments, the natural gas stream has a pressure of at least 500 psig and the polymer membrane exhibits (i) an H₂S/CH₄ selectivity increase of about 1% to about 15%; and/or (ii) a CO₂/CH₄ selectivity increase of about 40% to about 60%; as compared to the same polymer membrane including 6FDA-DAM polymer.

Also provided in the present disclosure are methods of preparing a polymer membrane, including providing a polymer solution including a solvent and a polymer, where the polymer is selected from 6FDA-DAM/DABA (3:1) and 6FDA-DAM/DABA (5:1); evaporating the solvent to form a polymer membrane film; and thermally treating the polymer membrane film to form the polymer membrane.

In some embodiments, thermally treating the polymer membrane film includes heating the polymer membrane film to about 200° C. for about 24 hours.

### DESCRIPTION OF DRAWINGS

FIG. 1 shows a schematic representation of 6FDA-DAM/DABA polyimide.

FIG. 2A shows a graph of the permeability and selectivity of the 6FDA-DAM/DABA polyimide membranes for a gas stream containing a ternary mixture of 5% H₂S, 3% CO₂, and 92% CH₄ by volume at 25° C. and 800 psig. The permeability and selectivity of commercial membranes under the same conditions is shown for comparison.

FIG. 2B shows a graph of the permeability and selectivity of the 6FDA-DAM/DABA polyimide membranes for a gas stream containing a ternary mixture of 5% H₂S, 3% CO₂, and 92% CH₄ by volume at 25° C. at both 200 and 800 psig.

FIG. 3 shows a graph of the permeability and selectivity of the 6FDA-DAM/DABA polyimide membranes for a gas stream containing a mixture of 20% H₂S, 10% CO₂, 57% CH₄, 3% C₂H₆, and 10% N₂ by volume at 25° C. at both 200 and 800 psig. The permeability and selectivity of 6FDA-DAM under the same conditions is shown for comparison.

FIG. 4A shows a graph of the H₂S permeability and H₂S/CH₄ selectivity of the 6FDA-DAM/DABA polyimide membranes for gas streams containing mixtures of 5% H₂S, 3% CO₂, and 92% CH₄ and 20% H₂S, 10% CO₂, 57% CH₄, 3% C₂H₆, and 10% N₂ by volume at 25° C. at 800 psig. The permeability and selectivity of both commercial membranes and 6FDA-DAM under the same conditions is shown for comparison.

FIG. 4B shows a graph of the CO₂ permeability and CO₂/CH₄ selectivity of the 6FDA-DAM/DABA polyimide membranes for gas streams containing mixtures of 5% H₂S, 3% CO₂, and 92% CH₄ and 20% H₂S, 10% CO₂, 57% CH₄, 3% C₂H₆, and 10% N₂ by volume at 25° C. at 800 psig. The permeability and selectivity of both commercial membranes and 6FDA-DAM under the same conditions is shown for comparison.

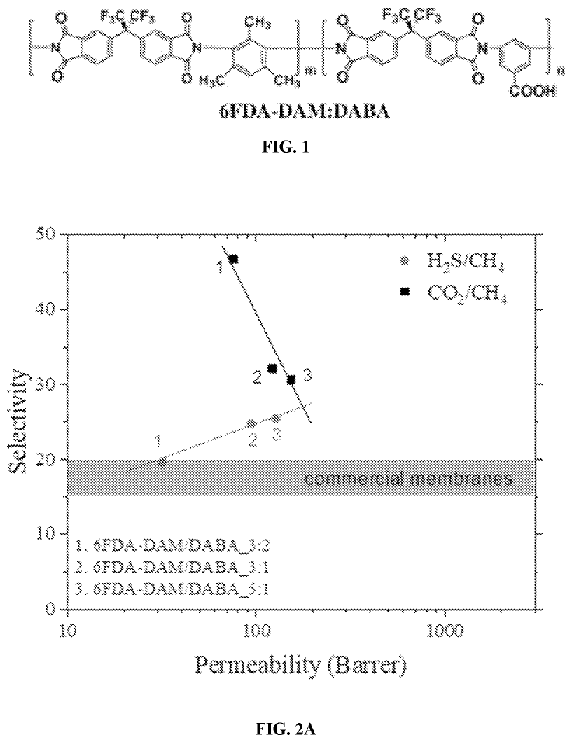

### DETAILED DESCRIPTION

The present disclosure relates to polymer membranes that can be used for industrial gas processing, having a combination of high permeability and high selectivity. The present disclosure relates to hybrid membranes including a polymer, and methods for making and using the polymer membranes for natural gas separation applications.

In general, H₂S in industrial process streams can be converted to elemental sulfur and water vapor via combustion in a sulfur recovery complex, called a Claus unit. When H₂S concentrations are sufficiently high, the energy released from the oxidation of H₂S may carry out the partial oxidation of H₂S and to eliminate other contaminants. However, when H₂S concentrations are low, then additional energy must be provided. Amine absorption processes are used to remove CO₂ and enrich H₂S in a sour gas before introducing it to Claus unit. However, it is very energy intensive using amine absorption systems if the concentration of H₂S is high (e.g., >20%).

The disclosed polymer membranes can help reduce the energy consumption compared to the amine absorption method. The disclosed polymer membranes include a polymer being a 6FDA-DAM/DABA polymer, selected from 6FDA-DAM/DABA (3:2), 6FDA-DAM/DABA (3:1), and 6FDA-DAM/DABA (5:1).

Varying the DAM to DABA ratio in the 6FDA-DAM/DABA polyimide system adjusts the concentration of carboxylic acid functional groups (e.g., —COOH) in the polymer membrane, which can tune the condensability (solubility) and molecular discrimination effect of the polymer membrane towards particular gases, such as hydrogen sulfide (H₂S) and carbon dioxide (CO₂). Without wishing to be bound by any particular theory, it is believed that the DABA subunit in 6FDA-DAM/DABA polyimide affects the membrane performance, while the DAM subunit interacts distinctively with H₂S compared to CO₂. Particularly, H₂S/CH₄ separations are dominated by the sorption factor, while and CO₂/CH₄ separations are dominated by the diffusion factor. In some embodiments, the disclosed polymers including 6FDA-DAM/DABA (3:2), 6FDA-DAM/DABA (3:1), and 6FDA-DAM/DABA (5:1) demonstrate distinct gas permeabilities and selectivities.

The disclosed polymer membranes exhibit increased H₂S/CH₄ and CO₂/CH₄ selectivities and increased H₂S and CO₂ permeabilities as compared to membranes including other polymers under various mixed gas conditions simulating realistic natural gas processing environments The disclosed polymer membranes exhibit increased H₂S/CH₄ and CO₂/CH₄ selectivities and increased H₂S and CO₂ permeabilities under various mixed gas conditions simulating realistic natural gas processing environments, including high pressure (e.g., 800 psig or greater) and high concentrations of acid gases (e.g., 20% or more of H₂S and/or 10% or more CO₂).

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

### Definitions

In this disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “about” as used herein can allow for a degree of variability in a value or range, for example, within 10%, within 5%, or within 1% of a stated value or of a stated limit of a range.

In the methods described in the present disclosure, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

### Polymers

The polymer membranes of the present disclosure contain a polymer. In some embodiments, the polymer is a co-polyimide polymer. In some embodiments, the polymer is a 4,4′-(hexafluoroisopropylidene) diphthalic anhydride (6FDA)-2,4,6-trimethyl-1,3-diaminobenzene (DAM)/3,5-diaminobenzoic acid (DABA) (6FDA-DAM/DABA). In some embodiments, the polymer is 6FDA-DAM:DABA and has the formula:

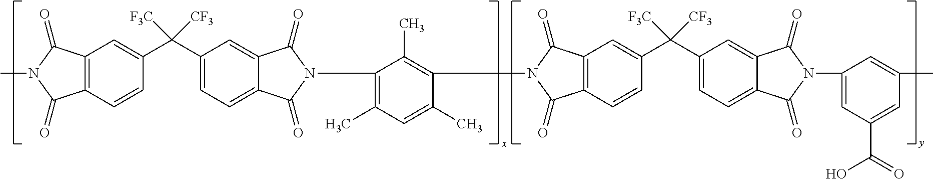

where x and y are integers based on the ratio of DAM to DABA.

In some embodiments, the polymer is selected from the group consisting of poly(2,4,6-trimethyl-1,3-phenylene-4,4′-(hexafluoroisopropylidene)diphthalimide-co-3,5-benzoic acid-4,4′-(hexafluorosopropylidene)diphthalimide)) (6FDA-DAM:DABA (3:1)), poly(2,4,6-trimethyl-1,3-phenylene-4,4′-(hexafluoroisopropylidene)diphthalimide-co-3,5-benzoic acid-4,4′-(hexafluorosopropylidene)diphthalimide)) (6FDA-DAM:DABA (3:2)), and poly(2,4,6-trimethyl-1,3-phenylene-4,4′-(hexafluoroisopropylidene)diphthalimide-co-3,5-benzoic acid-4,4′-(hexafluorosopropylidene)diphthalimide)) (6FDA-DAM:DABA (5:1)). The ratio in parentheses stands for the molar ratio of the components for each polymer. In some embodiments, the polymer is 6FDA-DAM/DABA (3:2). In some embodiments, the polymer is 6FDA-DAM/DABA (3:1) or 6FDA-DAM/DABA (5:1). In some embodiments, the polymer is 6FDA-DAM/DABA (3:1). In some embodiments, the polymer is 6FDA-DAM/DABA (5:1).

In some embodiments, the polymer membrane is thermally treated. In some embodiments, the polymer membrane is thermally treated before use in a method of separating carbon dioxide (CO₂) and hydrogen sulfide (H₂S) from natural gas.

### Methods of Preparing Polymer Membranes

Also provided are methods of preparing the polymer membranes of the present disclosure. In some embodiments, provided is a process of making a polymer membranes that can be used for industrial gas processing, having a combination of high permeability and high selectivity. In some embodiments, the polymer membranes includes a polymer. In some embodiments, the polymer is a co-polyimide polymer. In some embodiments, the polymer is a 6FDA-DAM/DABA. In some embodiments, the polymer is selected from the group consisting of 6FDA-DAM/DABA (3:2), 6FDA-DAM/DABA (3:1), and 6FDA-DAM/DABA (5:1). In some embodiments, the polymer is 6FDA-DAM/DABA (3:2). In some embodiments, the polymer is 6FDA-DAM/DABA (3:1) or 6FDA-DAM/DABA (5:1). In some embodiments, the polymer is 6FDA-DAM/DABA (3:1). In some embodiments, the polymer is 6FDA-DAM/DABA (5:1).

In some embodiments, the method of preparing a polymer membrane includes:
providing a polymer solution including a solvent and a polymer, where the polymer is selected from 6FDA-DAM/DABA (3:1) and 6FDA-DAM/DABA (5:1);
evaporating the solvent to form a polymer membrane film; and
thermally treating the polymer membrane film to form the polymer membrane.

In some embodiments, the polymer solution includes 6FDA-DAM/DABA (3:1). In some embodiments, the polymer solution includes 6FDA-DAM/DABA (5:1).

In some embodiments, the polymer solution includes about 0.1 wt % to about 25 wt %, about 1 wt % to about 20 wt %, about 2 wt % to about 15 wt %, about 3 wt % to about 10 wt %, about 4 wt % to about 8 wt %, or about 4.5 wt % to about 5.5 wt % of the polymer. In some embodiments, the polymer solution includes about 0.1 wt % to about 25 wt % of the polymer. In some embodiments, the polymer solution includes about 1 wt % to about 20 wt % of the polymer. In some embodiments, the polymer solution includes about 2 wt % to about 15 wt % of the polymer. In some embodiments, the polymer solution includes about 3 wt % to about 10 wt % of the polymer. In some embodiments, the polymer solution includes about 4 wt % to about 8 wt % of the polymer. In some embodiments, the polymer solution includes about 4.5 wt % to about 5.5 wt % of the polymer.

In some embodiments, the polymer solution includes about 0.1 wt % of the polymer. In some embodiments, the polymer solution includes about 1 wt % of the polymer. In some embodiments, the polymer solution includes about 2 wt % of the polymer. In some embodiments, the polymer solution includes about 3 wt % of the polymer. In some embodiments, the polymer solution includes about 4 wt % of the polymer. In some embodiments, the polymer solution includes about 4.5 wt % of the polymer. In some embodiments, the polymer solution includes about 5 wt % of the polymer. In some embodiments, the polymer solution includes about 5.5 wt % of the polymer. In some embodiments, the polymer solution includes about 8 wt % of the polymer. In some embodiments, the polymer solution includes about 10 wt % of the polymer. In some embodiments, the polymer solution includes about 15 wt % of the polymer. In some embodiments, the polymer solution includes about 20 wt % of the polymer. In some embodiments, the polymer solution includes about 25 wt % of the polymer.

In some embodiments, the polymer solution includes about 0.1 wt % to about 25 wt %, about 1 wt % to about 20 wt %, about 2 wt % to about 15 wt %, about 3 wt % to about 10 wt %, about 4 wt % to about 8 wt %, or about 4.5 wt % to about 5.5 wt % of 6FDA-DAM:DABA (3:2).

In some embodiments, the polymer solution includes about 5 wt % of 6FDA-DAM:DABA (3:2).

In some embodiments, the polymer solution includes about 0.1 wt % to about 25 wt %, about 1 wt % to about 20 wt %, about 2 wt % to about 15 wt %, about 3 wt % to about 10 wt %, about 4 wt % to about 8 wt %, or about 4.5 wt % to about 5.5 wt % of 6FDA-DAM:DABA (3:1).

In some embodiments, the polymer solution includes about 5 wt % of 6FDA-DAM:DABA (3:1).

In some embodiments, the polymer solution includes about 0.1 wt % to about 25 wt %, about 1 wt % to about 20 wt %, about 2 wt % to about 15 wt %, about 3 wt % to about 10 wt %, about 4 wt % to about 8 wt %, or about 4.5 wt % to about 5.5 wt % of 6FDA-DAM:DABA (5:1).

In some embodiments, the polymer solution includes about 5 wt % of 6FDA-DAM:DABA (5:1).

In some embodiments, the solvent is selected from ethanol, butanol, 2-ethylhexanol, isobutanol, isopropanol, methanol, propanol, propylene glycol, dimethylformamide, pyridine, n-hexane, cyclohexane, acetone, methyl ethyl ketone, methyl isobutyl ketone, methyl isopropyl ketone, mesityl oxide, trichloroethylene, 1,4-dioxane, butyl ether, ethyl ether, diisopropyl ether, tetrahydrofuran, tert-butyl methyl ether, acetonitrile, water, ethylene bromide, chloroform, ethylene chloride, dichloromethane, tetrachloroethylene, carbon tetrachloride, dimethyl sulfoxide, ethyl acetate, toluene, xylenes, and combinations thereof. In some embodiments, the solvent is tetrahydrofuran.

In some embodiments, the polymer solution includes about 0.1 wt % to about 25 wt %, about 1 wt % to about 20 wt %, about 2 wt % to about 15 wt %, about 3 wt % to about 10 wt %, about 4 wt % to about 8 wt %, or about 4.5 wt % to about 5.5 wt % of 6FDA-DAM:DABA (3:2), where the solvent is tetrahydrofuran.

In some embodiments, the polymer solution includes about 5 wt % of 6FDA-DAM:DABA (3:2), where the solvent is tetrahydrofuran.

In some embodiments, the polymer solution includes about 0.1 wt % to about 25 wt %, about 1 wt % to about 20 wt %, about 2 wt % to about 15 wt %, about 3 wt % to about 10 wt %, about 4 wt % to about 8 wt %, or about 4.5 wt % to about 5.5 wt % of 6FDA-DAM:DABA (3:1), where the solvent is tetrahydrofuran.

In some embodiments, the polymer solution includes about 5 wt % of 6FDA-DAM:DABA (3:1), where the solvent is tetrahydrofuran.

In some embodiments, the polymer solution includes about 0.1 wt % to about 25 wt %, about 1 wt % to about 20 wt %, about 2 wt % to about 15 wt %, about 3 wt % to about 10 wt %, about 4 wt % to about 8 wt %, or about 4.5 wt % to about 5.5 wt % of 6FDA-DAM:DABA (5:1), where the solvent is tetrahydrofuran.

In some embodiments, the polymer solution includes about 5 wt % of 6FDA-DAM:DABA (5:1), where the solvent is tetrahydrofuran.

In some embodiments, the polymer membrane film has a thickness of about 25 μm to about 150 μm, about 50 μm to about 125 μm, about 60 μm to about 110 μm, about 65 μm to about 100 μm, or about 70 μm to about 90 μm. In some embodiments, the polymer membrane film has a thickness of about 25 μm to about 150 μm. In some embodiments, the polymer membrane film has a thickness of about 50 μm to about 125 μm. In some embodiments, the polymer membrane film has a thickness of about 60 μm to about 110 μm. In some embodiments, the polymer membrane film has a thickness of about 65 μm to about 100 μm. In some embodiments, the polymer membrane film has a thickness of about 70 μm to about 90 μm.

In some embodiments, the polymer membrane is thermally treated. Thermal treatment of the polymer membrane may include annealing the polymer membrane at high temperature. Thermal treatment of the polymer membrane may improve the H₂S/CH₄ selectivity of the polymer membrane. Thermal treatment of the polymer membrane may improve the H₂S/CH₄ selectivity of the polymer membrane under high-pressure environments and/or H₂S-rich environments. Thermal treatment of the polymer membrane may improve the H₂S and/or CO₂ permeability of the polymer membrane under high-pressure environments and/or H₂S-rich environments.

In some embodiments, the thermal treating is performed under reduced pressure.

In some embodiments, the thermal treating is performed for about 5 minutes. In some embodiments, the thermal treating is performed for about 15 minutes. In some embodiments, the thermal treating is performed for about 30 minutes. In some embodiments, the thermal treating is performed for about 1 hour. In some embodiments, the thermal treating is performed for about 2 hours. In some embodiments, the thermal treating is performed for about 4 hours. In some embodiments, the thermal treating is performed for about 6 hours. In some embodiments, the thermal treating is performed for about 8 hours. In some embodiments, the thermal treating is performed for about 10 hours. In some embodiments, the thermal treating is performed for about 12 hours. In some embodiments, the thermal treating is performed for about 14 hours. In some embodiments, the thermal treating is performed for about 16 hours. In some embodiments, the thermal treating is performed for about 18 hours. In some embodiments, the thermal treating is performed for about 20 hours. In some embodiments, the thermal treating is performed for about 24 hours. In some embodiments, the thermal treating is performed for about 48 hours. In some embodiments, the thermal treating is performed for about 72 hours. In some embodiments, the thermal treating is performed for about 96 hours. In some embodiments, the thermal treating is performed overnight.

In some embodiments, the thermal treating is performed at about 100° C. to about 300° C. In some embodiments, the thermal treating is performed at about 120° C. to about 280° C. In some embodiments, the thermal treating is performed at about 140° C. to about 260° C. In some embodiments, the thermal treating is performed at about 160° C. to about 240° C. In some embodiments, the thermal treating is performed at about 180° C. to about 220° C. In some embodiments, the thermal treating is performed at about 190° C. to about 210° C. In some embodiments, the thermal treating is performed at about 200° C.

In some embodiments, the thermal treating is performed under reduced pressure at about 200° C.

In some embodiments, the thermal treating is performed under reduced pressure for about 24 hours.

In some embodiments, the thermal treating is performed at about 200° C. for about 24 hours.

In some embodiments, the thermal treating is performed under reduced pressure at about 200° C. for about 24 hours.

Also provided in the present disclosure are polymer membranes prepared by the methods described herein.

### Methods of Using the Polymer Membranes

Polymer membranes are thin semipermeable barriers that selectively separate some gas compounds from others. The polymer membranes are dense films that do not operate as a filter, but rather separate gas compounds based on how well the different compounds dissolve into the membrane and diffuse through it (the solution-diffusion model). The polymer membranes of the present disclosure can be used for any gas separation application, including, but not limited to, natural gas sweetening, oxygen enrichment, hydrogen purification, and nitrogen and organic compounds removal from natural gas. In some embodiments, the polymer membranes of the present disclosure are used for the bulk removal of acid gases from natural gas.

In some embodiments, the method of separating carbon dioxide (CO₂) and hydrogen sulfide (H₂S) from natural gas includes:
providing a polymer membrane including a polymer selected from 6FDA-DAM/DABA (3:2), 6FDA-DAM/DABA (3:1), and 6FDA-DAM/DABA (5:1);
introducing a natural gas stream to the polymer membrane, where the natural gas stream includes CO₂, H₂S, and methane (CH₄), and the natural gas stream includes at least about 5% H₂S by volume; and
removing carbon dioxide (CO₂) and hydrogen sulfide (H₂S) from the natural gas.

In some embodiments, the method of separating carbon dioxide (CO₂) and hydrogen sulfide (H₂S) from natural gas includes:
providing a polymer membrane including a polymer selected from 6FDA-DAM/DABA (3:1) and 6FDA-DAM/DABA (5:1);
introducing a natural gas stream to the polymer membrane, where the natural gas stream includes CO₂, H₂S, and methane (CH₄), and the natural gas stream includes at least about 5% H₂S by volume; and
removing carbon dioxide (CO₂) and hydrogen sulfide (H₂S) from the natural gas.

In some embodiments, the method of separating carbon dioxide (CO₂) and hydrogen sulfide (H₂S) from natural gas includes:
providing a polymer membrane including a polymer selected from 6FDA-DAM/DABA (3:2), 6FDA-DAM/DABA (3:1), and 6FDA-DAM/DABA (5:1);
introducing a natural gas stream to the polymer membrane, where the natural gas stream has a pressure of at least 500 psig; and
removing carbon dioxide (CO₂) and hydrogen sulfide (H₂S) from the natural gas.

In some embodiments, the method of separating carbon dioxide (CO₂) and hydrogen sulfide (H₂S) from natural gas includes:
providing a polymer membrane including a polymer selected from 6FDA-DAM/DABA (3:1) and 6FDA-DAM/DABA (5:1);
introducing a natural gas stream to the polymer membrane, where the natural gas stream has a pressure of at least 500 psig; and
removing carbon dioxide (CO₂) and hydrogen sulfide (H₂S) from the natural gas.

In some embodiments, the method of separating carbon dioxide (CO₂) and hydrogen sulfide (H₂S) from natural gas includes:
providing a polymer membrane including a polymer selected from 6FDA-DAM/DABA (3:2), 6FDA-DAM/DABA (3:1), and 6FDA-DAM/DABA (5:1);
introducing a natural gas stream to the polymer membrane, where the natural gas stream has a pressure of at least 500 psig and includes at least about 5% H₂S by volume; and
removing carbon dioxide (CO₂) and hydrogen sulfide (H₂S) from the natural gas.

In some embodiments, the method of separating carbon dioxide (CO₂) and hydrogen sulfide (H₂S) from natural gas includes:
providing a polymer membrane including a polymer selected from 6FDA-DAM/DABA (3:1) and 6FDA-DAM/DABA (5:1);
introducing a natural gas stream to the polymer membrane, where the natural gas stream has a pressure of at least 500 psig and includes at least about 5% H₂S by volume; and
removing carbon dioxide (CO₂) and hydrogen sulfide (H₂S) from the natural gas.

In some embodiments, the polymer is 6FDA-DAM/DABA (3:1). In some embodiments, the polymer is 6FDA-DAM/DABA (5:1).

In some embodiments, the natural gas stream includes about 5% to about 30% H₂S by volume, about 5% to about 25% H₂S by volume, about 5% to about 20% H₂S by volume, about 5% to about 18% H₂S by volume, about 5% to about 16% H₂S by volume, about 5% to about 14% H₂S by volume, about 5% to about 12% H₂S by volume, about 5% to about 10% H₂S by volume, about 10% to about 20% H₂S by volume, about 12% to about 20% H₂S by volume, about 14% to about 20% H₂S by volume, about 16% to about 20% H₂S by volume, about 18% to about 20% H₂S by volume, or about 18% to about 22% H₂S by volume. In some embodiments, the natural gas stream includes about 5% to about 30% H₂S by volume. In some embodiments, the natural gas stream includes about 5% to about 25% H₂S by volume. In some embodiments, the natural gas stream includes about 5% to about 20% H₂S by volume. In some embodiments, the natural gas stream about 5% to about 18% H₂S by volume. In some embodiments, the natural gas stream includes about 5% to about 16% H₂S by volume. In some embodiments, the natural gas stream includes about 5% to about 14% H₂S by volume. In some embodiments, the natural gas stream includes about 5% to about 12% H₂S by volume. In some embodiments, the natural gas stream includes about 5% to about 10% H₂S by volume. In some embodiments, the natural gas stream includes about 10% to about 20% H₂S by volume. In some embodiments, the natural gas stream includes about 12% to about 20% H₂S by volume. In some embodiments, the natural gas stream includes about 14% to about 20% H₂S by volume. In some embodiments, the natural gas stream includes about 16% to about 20% H₂S by volume. In some embodiments, the natural gas stream includes about 18% to about 20% H₂S by volume. In some embodiments, the natural gas stream includes about 18% to about 22% H₂S by volume.

In some embodiments, the natural gas stream includes about 8% or more H₂S by volume. In some embodiments, the natural gas stream includes about 10% or more H₂S by volume. In some embodiments, the natural gas stream includes about 12% or more H₂S by volume. In some embodiments, the natural gas stream includes about 14% or more H₂S by volume. In some embodiments, the natural gas stream includes about 15% or more H₂S by volume. In some embodiments, the natural gas stream includes about 16% or more H₂S by volume. In some embodiments, the natural gas stream includes about 18% or more H₂S by volume. In some embodiments, the natural gas stream includes about 20% or more H₂S by volume. In some embodiments, the natural gas stream includes about 22% or more H₂S by volume. In some embodiments, the natural gas stream includes about 24% or more H₂S by volume. In some embodiments, the natural gas stream includes about 25% or more H₂S by volume. In some embodiments, the natural gas stream includes about 30% or more H₂S by volume. In some embodiments, the natural gas stream includes about 35% or more H₂S by volume. In some embodiments, the natural gas stream includes about 40% or more H₂S by volume. In some embodiments, the natural gas stream includes about 45% or more H₂S by volume. In some embodiments, the natural gas stream includes about 50% or more H₂S by volume. In some embodiments, the natural gas stream includes about 60% or more H₂S by volume. In some embodiments, the natural gas stream includes about 70% or more H₂S by volume. In some embodiments, the natural gas stream includes about 80% or more H₂S by volume. In some embodiments, the natural gas stream includes about 90% or more H₂S by volume. In some embodiments, the natural gas stream includes about 95% or more H₂S by volume.

In some embodiments, the natural gas stream includes about 1% to about 20% CO₂ by volume. In some embodiments, the natural gas stream includes about 3% to about 15% CO₂ by volume. In some embodiments, the natural gas stream includes about 5% to about 15% CO₂ by volume. In some embodiments, the natural gas stream includes about 7% to about 15% CO₂ by volume. In some embodiments, the natural gas stream includes about 9% to about 15% CO₂ by volume. In some embodiments, the natural gas stream includes about 11% to about 15% CO₂ by volume. In some embodiments, the natural gas stream includes about 13% to about 15% CO₂ by volume. In some embodiments, the natural gas stream includes about 3% to about 13% CO₂ by volume. In some embodiments, the natural gas stream includes about 3% to about 11% CO₂ by volume. In some embodiments, the natural gas stream includes about 3% to about 9% CO₂ by volume. In some embodiments, the natural gas stream includes about 3% to about 7% CO₂ by volume. In some embodiments, the natural gas stream includes about 3% to about 5% CO₂ by volume. In some embodiments, the natural gas stream includes about 5% to about 13% CO₂ by volume. In some embodiments, the natural gas stream includes about 9% to about 11% CO₂ by volume.

In some embodiments, the natural gas stream includes at least 3% CO₂ by volume. In some embodiments, the natural gas stream includes at least 5% CO₂ by volume. In some embodiments, the natural gas stream includes at least 6% CO₂ by volume. In some embodiments, the natural gas stream includes at least 8% CO₂ by volume. In some embodiments, the natural gas stream includes at least 10% CO₂ by volume. In some embodiments, the natural gas stream includes at least 12% CO₂ by volume. In some embodiments, the natural gas stream includes at least 14% CO₂ by volume. In some embodiments, the natural gas stream includes at least 15% CO₂ by volume. In some embodiments, the natural gas stream includes at least 16% CO₂ by volume. In some embodiments, the natural gas stream includes at least 18% CO₂ by volume. In some embodiments, the natural gas stream includes at least 20% CO₂ by volume. In some embodiments, the natural gas stream includes at least 25% CO₂ by volume. In some embodiments, the natural gas stream includes at least 30% CO₂ by volume. In some embodiments, the natural gas stream includes at least 40% CO₂ by volume. In some embodiments, the natural gas stream includes at least 50% CO₂ by volume. In some embodiments, the natural gas stream includes at least 60% CO₂ by volume. In some embodiments, the natural gas stream includes at least 70% CO₂ by volume. In some embodiments, the natural gas stream includes at least 80% CO₂ by volume. In some embodiments, the natural gas stream includes at least 90% CO₂ by volume. In some embodiments, the natural gas stream includes at least 95% CO₂ by volume.

In some embodiments, the natural gas stream includes about 5% to about 20% H₂S and about 3% to about 15% CO₂ by volume. In some embodiments, the natural gas stream includes about 5% to about 30% H₂S and about 1% to about 20% CO₂ by volume.

In some embodiments, the natural gas stream includes about 10% or more H₂S and at least 5% CO₂ by volume. In some embodiments, the natural gas stream includes about 15% or more H₂S and at least 8% CO₂ by volume. In some embodiments, the natural gas stream includes about 20% or more H₂S and at least 10% CO₂ by volume.

In some embodiments, the natural gas stream further includes ethane (C₂H₆), ethylene (C₂H₄), C₃₊ hydrocarbons, nitrogen (N₂), water (H₂O), and combinations thereof. In some embodiments, the natural gas stream further includes ethane (C₂H₆). In some embodiments, the natural gas stream further includes ethylene (C₂H₄). In some embodiments, the natural gas stream further includes C₃₊ hydrocarbons. In some embodiments, the natural gas stream further includes nitrogen (N₂). In some embodiments, the natural gas stream further includes water (H₂O). In some embodiments, the natural gas stream further includes ethane (C₂H₆) and ethylene (C₂H₄). In some embodiments, the natural gas stream further includes ethane (C₂H₆) and nitrogen (N₂). In some embodiments, the natural gas stream further includes ethane (C₂H₆), ethylene (C₂H₄), and nitrogen (N₂). In some embodiments, the natural gas stream further includes ethane (C₂H₆), ethylene (C₂H₄), C₃₊ hydrocarbons, nitrogen (N₂), and water (H₂O).

In some embodiments, the C₃₊-hydrocarbons include propane, n-butane, isopropane, n-pentane, isobutane, propylene, propyne, 1,3-butadiene, isobutylene, butyne, pentene, pentyne, and combinations thereof.

In some embodiments, the natural gas stream has a pressure of about 500 psig to about 1100 psig, about 600 psig to about 1000 psig, about 700 psig to about 900 psig, or about 750 psig to about 850 psig. In some embodiments, the natural gas stream has a pressure of about 500 psig to about 1100 psig. In some embodiments, the natural gas stream has a pressure of about 600 psig to about 1000 psig. In some embodiments, the natural gas stream has a pressure of about 700 psig to about 900 psig. In some embodiments, the natural gas stream has a pressure of about 750 psig to about 850 psig.

In some embodiments, the natural gas stream has a pressure of at least about 500 psig. In some embodiments, the natural gas stream has a pressure of at least about 600 psig. In some embodiments, the natural gas stream has a pressure of at least about 700 psig. In some embodiments, the natural gas stream has a pressure of at least about 750 psig. In some embodiments, the natural gas stream has a pressure of at least about 800 psig. In some embodiments, the natural gas stream has a pressure of at least about 850 psig. In some embodiments, the natural gas stream has a pressure of at least about 900 psig. In some embodiments, the natural gas stream has a pressure of at least about 1000 psig. In some embodiments, the natural gas stream has a pressure of at least about 1100 psig. In some embodiments, the natural gas stream has a pressure of at least about 1200 psig.

In some embodiments, the H₂S has a permeability of about 75 to about 150 Barrer, about 85 to about 135 Barrer, about 90 to about 130 Barrer, about 95 to about 125 Barrer, about 100 to about 120 Barrer, about 105 to about 115 Barrer, about 75 to about 135 Barrer, about 75 to about 130 Barrer, about 75 to about 125 Barrer, about 85 to about 150 Barrer, about 90 to about 150 Barrer, about 100 to about 150 Barrer, about 110 to about 150 Barrer, about 120 to about 150 Barrer, about 125 to about 150 Barrer. In some embodiments, the H₂S has a permeability of about 75 to about 150 Barrer. In some embodiments, the H₂S has a permeability of about 85 to about 135 Barrer. In some embodiments, the H₂S has a permeability of about 90 to about 130 Barrer. In some embodiments, the H₂S has a permeability of about 95 to about 125 Barrer. In some embodiments, the H₂S has a permeability of about 100 to about 120 Barrer. In some embodiments, the H₂S has a permeability of about 105 to about 115 Barrer. In some embodiments, the H₂S has a permeability of about 75 to about 135 Barrer. In some embodiments, the H₂S has a permeability of about 75 to about 130 Barrer. In some embodiments, the H₂S has a permeability of about 75 to about 125 Barrer. In some embodiments, the H₂S has a permeability of about 85 to about 150 Barrer. In some embodiments, the H₂S has a permeability of about 90 to about 150 Barrer. In some embodiments, the H₂S has a permeability of about 100 to about 150 Barrer. In some embodiments, the H₂S has a permeability of about 110 to about 150 Barrer. In some embodiments, the H₂S has a permeability of about 120 to about 150 Barrer. In some embodiments, the H₂S has a permeability of about 125 to about 150 Barrer.

In some embodiments, the H₂S/CH₄ selectivity is about 15 to about 30, about 18 to about 27, about 20 to about 25, about 15 to about 27, about 15 to about 25, about 15 to about 22, about 15 to about 20, about 18 to about 30, about 20 to about 30, about 22 to about 30, or about 25 to about 30. In some embodiments, the H₂S/CH₄ selectivity is about 15 to about 30. In some embodiments, the H₂S/CH₄ selectivity is about 18 to about 27. In some embodiments, the H₂S/CH₄ selectivity is about 20 to about 25. In some embodiments, the H₂S/CH₄ selectivity is about 15 to about 27. In some embodiments, the H₂S/CH₄ selectivity is about 15 to about 25. In some embodiments, the H₂S/CH₄ selectivity is about 15 to about 22. In some embodiments, the H₂S/CH₄ selectivity is about 15 to about 20. In some embodiments, the H₂S/CH₄ selectivity is about 18 to about 30. In some embodiments, the H₂S/CH₄ selectivity is about 20 to about 30. In some embodiments, the H₂S/CH₄ selectivity is about 22 to about 30. In some embodiments, the H₂S/CH₄ selectivity is about 25 to about 30.

In some embodiments, the CO₂ has a permeability of about 100 to about 220 Barrer, about 120 to about 200 Barrer, about 130 to about 190 Barrer, about 140 to about 180 Barrer, about 150 to about 170 Barrer, about 100 to about 200 Barrer, about 100 to about 180 Barrer, about 100 to about 160 Barrer, about 100 to about 140 Barrer, about 100 to about 120 Barrer, about 120 to about 220 Barrer, about 140 to about 220 Barrer, about 160 to about 220 Barrer, about 180 to about 220 Barrer, or about 200 to about 220 Barrer. In some embodiments, the CO₂ has a permeability of about 100 to about 220 Barrer. In some embodiments, the CO₂ has a permeability of about 120 to about 200 Barrer. In some embodiments, the CO₂ has a permeability of about 130 to about 190 Barrer. In some embodiments, the CO₂ has a permeability of about 140 to about 180 Barrer. In some embodiments, the CO₂ has a permeability of about 150 to about 170 Barrer. In some embodiments, the CO₂ has a permeability of about 100 to about 200 Barrer. In some embodiments, the CO₂ has a permeability of about 100 to about 180 Barrer. In some embodiments, the CO₂ has a permeability of about 100 to about 160 Barrer. In some embodiments, the CO₂ has a permeability of about 100 to about 140 Barrer. In some embodiments, the CO₂ has a permeability of about 100 to about 120 Barrer. In some embodiments, the CO₂ has a permeability of about 120 to about 220 Barrer. In some embodiments, the CO₂ has a permeability of about 140 to about 220 Barrer. In some embodiments, the CO₂ has a permeability of about 160 to about 220 Barrer. In some embodiments, the CO₂ has a permeability of about 180 to about 220 Barrer. In some embodiments, the CO₂ has a permeability of about 200 to about 220 Barrer. In some embodiments, the CO₂/CH₄ selectivity is about 20 to about 40, about 24 to about 36, about 26 to about 34, about 28 to about 32, about 20 to about 36, about 20 to about 32, about 20 to about 28, about 20 to about 24, about 24 to about 40, about 28 to about 40, about 32 to about 40, or about 36 to about 40. In some embodiments, the CO₂/CH₄ selectivity is about 20 to about 40. In some embodiments, the CO₂/CH₄ selectivity is about 24 to about 36. In some embodiments, the CO₂/CH₄ selectivity is about 26 to about 34. In some embodiments, the CO₂/CH₄ selectivity is about 28 to about 32. In some embodiments, the CO₂/CH₄ selectivity is about 20 to about 36. In some embodiments, the CO₂/CH₄ selectivity is about 20 to about 32. In some embodiments, the CO₂/CH₄ selectivity is about 20 to about 28. In some embodiments, the CO₂/CH₄ selectivity is about 20 to about 24. In some embodiments, the CO₂/CH₄ selectivity is about 24 to about 40. In some embodiments, the CO₂/CH₄ selectivity is about 28 to about 40. In some embodiments, the CO₂/CH₄ selectivity is about 32 to about 40. In some embodiments, the CO₂/CH₄ selectivity is about 36 to about 40.

In some embodiments:
(i) the H₂S has a permeability of about 85 to about 135 Barrer;
(ii) the H₂S/CH₄ selectivity is about 15 to about 27;
(iii) the CO₂ has a permeability of about 120 to about 200 Barrer; and/or
(iv) the CO₂/CH₄ selectivity is about 24 to about 36.

In some embodiments, the CH₄ has a permeability of about 2 to about 10 Barrer, about 3 to about 8 Barrer, about 4 to about 6 Barrer, about 2 to about 8 Barrer, about 2 to about 6 Barrer, about 2 to about 4 Barrer, about 3 to about 10 Barrer, about 4 to about 10 Barrer, about 5 to about 10 Barrer, about 6 to about 10 Barrer, or about 8 to about 10 Barrer. In some embodiments, the CH₄ has a permeability of about 2 to about 10 Barrer. In some embodiments, the CH₄ has a permeability of about 3 to about 8 Barrer. In some embodiments, the CH₄ has a permeability of about 4 to about 6 Barrer. In some embodiments, the CH₄ has a permeability of about 2 to about 8 Barrer. In some embodiments, the CH₄ has a permeability of about 2 to about 6 Barrer. In some embodiments, the CH₄ has a permeability of about 2 to about 4 Barrer. In some embodiments, the CH₄ has a permeability of about 3 to about 10 Barrer. In some embodiments, the CH₄ has a permeability of about 4 to about 10 Barrer. In some embodiments, the CH₄ has a permeability of about 5 to about 10 Barrer. In some embodiments, the CH₄ has a permeability of about 6 to about 10 Barrer.

In some embodiments, the polymer membrane exhibits an H₂S permeability increase of about 140% to about 310% as compared to the same polymer membrane including a different polymer.

In some embodiments, the polymer membrane exhibits an H₂S/CH₄ selectivity increase of about 10% to about 35% as compared to the same polymer membrane including a different polymer.

In some embodiments, the polymer membrane exhibits a CO₂ permeability increase of about 30% to about 230% as compared to the same polymer membrane including a different polymer.

In some embodiments, the polymer membrane exhibits an H₂S permeability increase of about 140% to about 310% as compared to the same polymer membrane including 6FDA-DAM/DABA (3:2) polymer.

In some embodiments, the polymer membrane exhibits an H₂S/CH₄ selectivity increase of about 10% to about 35% as compared to the same polymer membrane including 6FDA-DAM/DABA (3:2) polymer.

In some embodiments, the polymer membrane exhibits a CO₂ permeability increase of about 30% to about 230% as compared to the same polymer membrane including 6FDA-DAM/DABA (3:2) polymer.

In some embodiments, the polymer membrane exhibits:
(i) an H₂S permeability increase of about 140% to about 310%;
(ii) an H₂S/CH₄ selectivity increase of about 10% to about 35%; and/or
(iii) a CO₂ permeability increase of about 30% to about 230%;
   as compared to the same polymer membrane including a different polymer.

In some embodiments, the polymer membrane exhibits:
(i) an H₂S permeability increase of about 140% to about 310%;
(ii) an H₂S/CH₄ selectivity increase of about 10% to about 35%; and/or
(iii) a CO₂ permeability increase of about 30% to about 230%;
   as compared to the same polymer membrane including 6FDA-DAM/DABA (3:2) polymer.

In some embodiments, the natural gas stream includes at least about 20% H₂S by volume and the H₂S has a permeability of about 50 to about 600 Barrer, about 75 to about 550 Barrer, about 100 to about 500 Barrer, about 125 to about 450 Barrer, about 150 to about 400 Barrer, about 175 to about 350 Barrer, about 200 to about 300 Barrer, about 225 to about 250 Barrer, about 50 to about 500 Barrer, about 50 to about 400 Barrer, about 50 to about 300 Barrer, about 50 to about 200 Barrer, about 50 to about 100 Barrer, about 100 to about 600 Barrer, about 200 to about 600 Barrer, about 300 to about 600 Barrer, about 400 to about 600 Barrer, or about 500 to about 600 Barrer. In some embodiments, the natural gas stream includes at least about 20% H₂S by volume and the H₂S has a permeability of about 50 to about 600 Barrer. In some embodiments, the natural gas stream includes at least about 20% H₂S by volume and the H₂S has a permeability of about 75 to about 550 Barrer. In some embodiments, the natural gas stream includes at least about 20% H₂S by volume and the H₂S has a permeability of about 100 to about 500 Barrer. In some embodiments, the natural gas stream includes at least about 20% H₂S by volume and the H₂S has a permeability of about 125 to about 450 Barrer. In some embodiments, the natural gas stream includes at least about 20% H₂S by volume and the H₂S has a permeability of about 150 to about 400 Barrer. In some embodiments, the natural gas stream includes at least about 20% H₂S by volume and the H₂S has a permeability of about 175 to about 350 Barrer. In some embodiments, the natural gas stream includes at least about 20% H₂S by volume and the H₂S has a permeability of about 200 to about 300 Barrer. In some embodiments, the natural gas stream includes at least about 20% H₂S by volume and the H₂S has a permeability of about 225 to about 250 Barrer. In some embodiments, the natural gas stream includes at least about 20% H₂S by volume and the H₂S has a permeability of about 50 to about 500 Barrer. In some embodiments, the natural gas stream includes at least about 20% H₂S by volume and the H₂S has a permeability of about 50 to about 400 Barrer. In some embodiments, the natural gas stream includes at least about 20% H₂S by volume and the H₂S has a permeability of about 50 to about 300 Barrer. In some embodiments, the natural gas stream includes at least about 20% H₂S by volume and the H₂S has a permeability of about 50 to about 200 Barrer. In some embodiments, the natural gas stream includes at least about 20% H₂S by volume and the H₂S has a permeability of about 50 to about 100 Barrer. In some embodiments, the natural gas stream includes at least about 20% H₂S by volume and the H₂S has a permeability of about 100 to about 600 Barrer. In some embodiments, the natural gas stream includes at least about 20% H₂S by volume and the H₂S has a permeability of about 200 to about 600 Barrer. In some embodiments, the natural gas stream includes at least about 20% H₂S by volume and the H₂S has a permeability of about 300 to about 600 Barrer. In some embodiments, the natural gas stream includes at least about 20% H₂S by volume and the H₂S has a permeability of about 400 to about 600 Barrer. In some embodiments, the natural gas stream includes at least about 20% H₂S by volume and the H₂S has a permeability of about 500 to about 600 Barrer.

In some embodiments, the natural gas stream includes at least about 20% H₂S by volume and the H₂S/CH₄ selectivity is about 20 to about 35, about 24 to about 32, about 26 to about 30, about 20 to about 32, about 20 to about 28, about 20 to about 24, about 24 to about 35, about 28 to about 35, or about 32 to about 35. In some embodiments, the natural gas stream includes at least about 20% H₂S by volume and the H₂S/CH₄ selectivity is about 20 to about 35. In some embodiments, the natural gas stream includes at least about 20% H₂S by volume and the H₂S/CH₄ selectivity is about 24 to about 32. In some embodiments, the natural gas stream includes at least about 20% H₂S by volume and the H₂S/CH₄ selectivity is about 26 to about 30. In some embodiments, the natural gas stream includes at least about 20% H₂S by volume and the H₂S/CH₄ selectivity is about 20 to about 32. In some embodiments, the natural gas stream includes at least about 20% H₂S by volume and the H₂S/CH₄ selectivity is about 20 to about 28. In some embodiments, the natural gas stream includes at least about 20% H₂S by volume and the H₂S/CH₄ selectivity is about 20 to about 24. In some embodiments, the natural gas stream includes at least about 20% H₂S by volume and the H₂S/CH₄ selectivity is about 24 to about 35. In some embodiments, the natural gas stream includes at least about 20% H₂S by volume and the H₂S/CH₄ selectivity is about 28 to about 35. In some embodiments, the natural gas stream includes at least about 20% H₂S by volume and the H₂S/CH₄ selectivity is about 32 to about 35.

In some embodiments, the natural gas stream includes at least about 20% H₂S by volume and the CO₂ has a permeability of about 100 to about 350 Barrer, about 120 to about 300 Barrer, about 140 to about 275 Barrer, about 160 to about 250 Barrer, about 180 to about 225 Barrer, about 190 to about 200 Barrer, about 100 to about 300 Barrer, about 100 to about 250 Barrer, about 100 to about 200 Barrer, about 100 to about 150 Barrer, about 150 to about 350 Barrer, about 200 to about 350 Barrer, about 250 to about 350 Barrer, or about 300 to about 350 Barrer. In some embodiments, the natural gas stream includes at least about 20% H₂S by volume and the CO₂ has a permeability of about 100 to about 350 Barrer. In some embodiments, the natural gas stream includes at least about 20% H₂S by volume and the CO₂ has a permeability of about 120 to about 300 Barrer. In some embodiments, the natural gas stream includes at least about 20% H₂S by volume and the CO₂ has a permeability of about 140 to about 275 Barrer. In some embodiments, the natural gas stream includes at least about 20% H₂S by volume and the CO₂ has a permeability of about 160 to about 250 Barrer. In some embodiments, the natural gas stream includes at least about 20% H₂S by volume and the CO₂ has a permeability of about 180 to about 225 Barrer. In some embodiments, the natural gas stream includes at least about 20% H₂S by volume and the CO₂ has a permeability of about 190 to about 200 Barrer. In some embodiments, the natural gas stream includes at least about 20% H₂S by volume and the CO₂ has a permeability of about 100 to about 300 Barrer. In some embodiments, the natural gas stream includes at least about 20% H₂S by volume and the CO₂ has a permeability of about 100 to about 250 Barrer. In some embodiments, the natural gas stream includes at least about 20% H₂S by volume and the CO₂ has a permeability of about 100 to about 200 Barrer. In some embodiments, the natural gas stream includes at least about 20% H₂S by volume and the CO₂ has a permeability of about 100 to about 150 Barrer. In some embodiments, the natural gas stream includes at least about 20% H₂S by volume and the CO₂ has a permeability of about 150 to about 350 Barrer. In some embodiments, the natural gas stream includes at least about 20% H₂S by volume and the CO₂ has a permeability of about 200 to about 350 Barrer. In some embodiments, the natural gas stream includes at least about 20% H₂S by volume and the CO₂ has a permeability of about 250 to about 350 Barrer. In some embodiments, the natural gas stream includes at least about 20% H₂S by volume and the CO₂ has a permeability of about 300 to about 350 Barrer.

In some embodiments, the natural gas stream includes at least about 20% H₂S by volume and the CO₂/CH₄ selectivity is about 15 to about 40, about 18 to about 36, about 22 to about 32, about 24 to about 30, about 26 to about 28, about 15 to about 36, about 15 to about 32, about 15 to about 28, about 15 to about 24, about 15 to about 20, about 18 to about 40, about 20 to about 40, about 24 to about 40, about 28 to about 40, about 32 to about 40, or about 36 to about 40. In some embodiments, the natural gas stream includes at least about 20% H₂S by volume and the CO₂/CH₄ selectivity is about 15 to about 40. In some embodiments, the natural gas stream includes at least about 20% H₂S by volume and the CO₂/CH₄ selectivity is about 18 to about 36. In some embodiments, the natural gas stream includes at least about 20% H₂S by volume and the CO₂/CH₄ selectivity is about 22 to about 32. In some embodiments, the natural gas stream includes at least about 20% H₂S by volume and the CO₂/CH₄ selectivity is about 24 to about 30. In some embodiments, the natural gas stream includes at least about 20% H₂S by volume and the CO₂/CH₄ selectivity is about 26 to about 28. In some embodiments, the natural gas stream includes at least about 20% H₂S by volume and the CO₂/CH₄ selectivity is about 15 to about 36. In some embodiments, the natural gas stream includes at least about 20% H₂S by volume and the CO₂/CH₄ selectivity is about 15 to about 32. In some embodiments, the natural gas stream includes at least about 20% H₂S by volume and the CO₂/CH₄ selectivity is about 15 to about 28. In some embodiments, the natural gas stream includes at least about 20% H₂S by volume and the CO₂/CH₄ selectivity is about 15 to about 24. In some embodiments, the natural gas stream includes at least about 20% H₂S by volume and the CO₂/CH₄ selectivity is about 15 to about 20. In some embodiments, the natural gas stream includes at least about 20% H₂S by volume and the CO₂/CH₄ selectivity is about 20 to about 40. In some embodiments, the natural gas stream includes at least about 20% H₂S by volume and the CO₂/CH₄ selectivity is about 24 to about 40. In some embodiments, the natural gas stream includes at least about 20% H₂S by volume and the CO₂/CH₄ selectivity is about 28 to about 40. In some embodiments, the natural gas stream includes at least about 20% H₂S by volume and the CO₂/CH₄ selectivity is about 32 to about 40. In some embodiments, the natural gas stream includes at least about 20% H₂S by volume and the CO₂/CH₄ selectivity is about 36 to about 40.

In some embodiments:
(i) the H₂S has a permeability of about 75 to about 550 Barrer;
(ii) the H₂S/CH₄ selectivity is about 20 to about 35;
(iii) the CO₂ has a permeability is about 120 to about 300 Barrer; and/or
(iv) the CO₂/CH₄ selectivity is about 15 to about 40;
   where the natural gas stream includes at least about 20% H₂S by volume.

In some embodiments, the natural gas stream includes at least about 20% H₂S by volume and the CH₄ has a permeability of about 2 to about 20 Barrer, about 3 to about 16 Barrer, about 4 to about 12 Barrer, about 5 to about 10 Barrer, about 6 to about 8 Barrer, about 2 to about 16 Barrer, about 2 to about 12 Barrer, about 2 to about 8 Barrer, about 2 to about 4 Barrer, about 4 to about 20 Barrer, about 8 to about 20 Barrer, about 12 to about 20 Barrer, or about 16 to about 20 Barrer. In some embodiments, the natural gas stream includes at least about 20% H₂S by volume and the CH₄ has a permeability of about 2 to about 20 Barrer In some embodiments, the natural gas stream includes at least about 20% H₂S by volume and the CH₄ has a permeability of about 3 to about 16 Barrer. In some embodiments, the natural gas stream includes at least about 20% H₂S by volume and the CH₄ has a permeability of about 4 to about 12 Barrer. In some embodiments, the natural gas stream includes at least about 20% H₂S by volume and the CH₄ has a permeability of about 5 to about 10 Barrer. In some embodiments, the natural gas stream includes at least about 20% H₂S by volume and the CH₄ has a permeability of about 6 to about 8 Barrer. In some embodiments, the natural gas stream includes at least about 20% H₂S by volume and the CH₄ has a permeability of about 2 to about 16 Barrer. In some embodiments, the natural gas stream includes at least about 20% H₂S by volume and the CH₄ has a permeability of about 2 to about 12 Barrer. In some embodiments, the natural gas stream includes at least about 20% H₂S by volume and the CH₄ has a permeability of about 2 to about 8 Barrer. In some embodiments, the natural gas stream includes at least about 20% H₂S by volume and the CH₄ has a permeability of about 2 to about 4 Barrer. In some embodiments, the natural gas stream includes at least about 20% H₂S by volume and the CH₄ has a permeability of about 4 to about 20 Barrer. In some embodiments, the natural gas stream includes at least about 20% H₂S by volume and the CH₄ has a permeability of about 8 to about 20 Barrer. In some embodiments, the natural gas stream includes at least about 20% H₂S by volume and the CH₄ has a permeability of about 12 to about 20 Barrer. In some embodiments, the natural gas stream includes at least about 20% H₂S by volume and the CH₄ has a permeability of about 16 to about 20 Barrer.

In some embodiments, the natural gas stream includes at least about 20% H₂S by volume and the polymer membrane exhibits an H₂S permeability increase of about 65% to about 320% as compared to the same polymer membrane including a different polymer.

In some embodiments, the natural gas stream includes at least about 20% H₂S by volume and the polymer membrane exhibits a CO₂ permeability increase of about 150% to about 270% as compared to the same polymer membrane including a different polymer.

In some embodiments, the natural gas stream includes at least about 20% H₂S by volume and the polymer membrane exhibits an H₂S permeability increase of about 65% to about 320% as compared to the same polymer membrane including 6FDA-DAM/DABA (3:2) polymer.

In some embodiments, the natural gas stream includes at least about 20% H₂S by volume and the polymer membrane exhibits a CO₂ permeability increase of about 150% to about 270% as compared to the same polymer membrane including 6FDA-DAM/DABA (3:2) polymer.

In some embodiments, the natural gas stream includes at least about 20% H₂S by volume and the polymer membrane exhibits:
(i) an H₂S permeability increase of about 65% to about 320%; and/or
(ii) a CO₂ permeability increase of about 150% to about 270%;
   as compared to the same polymer membrane including a different polymer.

In some embodiments, the natural gas stream includes at least about 20% H₂S by volume and the polymer membrane exhibits:
(i) an H₂S permeability increase of about 65% to about 320%; and/or
(ii) a CO₂ permeability increase of about 150% to about 270%;
   as compared to the same polymer membrane including 6FDA-DAM/DABA (3:2) polymer.

In some embodiments, the natural gas stream includes at least about 20% H₂S by volume and the polymer membrane exhibits an H₂S/CH₄ selectivity increase of about 1% to about 15% as compared to the same polymer membrane including a different polymer.

In some embodiments, the natural gas stream includes at least about 20% H₂S by volume and the polymer membrane exhibits a CO₂/CH₄ selectivity increase of about 40% to about 60% as compared to the same polymer membrane including a different polymer.

In some embodiments, the natural gas stream includes at least about 20% H₂S by volume and the polymer membrane exhibits:
(i) an H₂S/CH₄ selectivity increase of about 1% to about 15%; and/or
(ii) a CO₂/CH₄ selectivity increase of about 40% to about 60%;
   as compared to the same polymer membrane including a different polymer.

In some embodiments, the natural gas stream includes at least about 20% H₂S by volume and the polymer membrane exhibits an H₂S/CH₄ selectivity increase of about 1% to about 15% as compared to the same polymer membrane including 6FDA-DAM polymer.

In some embodiments, the natural gas stream includes at least about 20% H₂S by volume and the polymer membrane exhibits a CO₂/CH₄ selectivity increase of about 40% to about 60% as compared to the same polymer membrane including 6FDA-DAM polymer.

In some embodiments, the natural gas stream includes at least about 20% H₂S by volume and the polymer membrane exhibits:
(i) an H₂S/CH₄ selectivity increase of about 1% to about 15%; and/or
(ii) a CO₂/CH₄ selectivity increase of about 40% to about 60%;
   as compared to the same polymer membrane including 6FDA-DAM polymer.

In some embodiments, the natural gas stream has a pressure of at least 500 psig and the H₂S has a permeability of about 50 to about 600 Barrer, about 75 to about 550 Barrer, about 100 to about 500 Barrer, about 125 to about 450 Barrer, about 150 to about 400 Barrer, about 175 to about 350 Barrer, about 200 to about 300 Barrer, about 225 to about 250 Barrer, about 50 to about 500 Barrer, about 50 to about 400 Barrer, about 50 to about 300 Barrer, about 50 to about 200 Barrer, about 50 to about 100 Barrer, about 100 to about 600 Barrer, about 200 to about 600 Barrer, about 300 to about 600 Barrer, about 400 to about 600 Barrer, or about 500 to about 600 Barrer. In some embodiments, the natural gas stream has a pressure of at least 500 psig and the H₂S has a permeability of about 50 to about 600 Barrer. In some embodiments, the natural gas stream has a pressure of at least 500 psig and the H₂S has a permeability of about 75 to about 550 Barrer. In some embodiments, the natural gas stream has a pressure of at least 500 psig and the H₂S has a permeability of about 100 to about 500 Barrer. In some embodiments, the natural gas stream has a pressure of at least 500 psig and the H₂S has a permeability of about 125 to about 450 Barrer. In some embodiments, the natural gas stream has a pressure of at least 500 psig and the H₂S has a permeability of about 150 to about 400 Barrer. In some embodiments, the natural gas stream has a pressure of at least 500 psig and the H₂S has a permeability of about 175 to about 350 Barrer. In some embodiments, the natural gas stream has a pressure of at least 500 psig and the H₂S has a permeability of about 200 to about 300 Barrer. In some embodiments, the natural gas stream has a pressure of at least 500 psig and the H₂S has a permeability of about 225 to about 250 Barrer. In some embodiments, the natural gas stream has a pressure of at least 500 psig and the H₂S has a permeability of about 50 to about 500 Barrer. In some embodiments, the natural gas stream has a pressure of at least 500 psig and the H₂S has a permeability of about 50 to about 400 Barrer. In some embodiments, the natural gas stream has a pressure of at least 500 psig and the H₂S has a permeability of about 50 to about 300 Barrer. In some embodiments, the natural gas stream has a pressure of at least 500 psig and the H₂S has a permeability of about 50 to about 200 Barrer. In some embodiments, the natural gas stream has a pressure of at least 500 psig and the H₂S has a permeability of about 50 to about 100 Barrer. In some embodiments, the natural gas stream has a pressure of at least 500 psig and the H₂S has a permeability of about 100 to about 600 Barrer. In some embodiments, the natural gas stream has a pressure of at least 500 psig and the H₂S has a permeability of about 200 to about 600 Barrer. In some embodiments, the natural gas stream has a pressure of at least 500 psig and the H₂S has a permeability of about 300 to about 600 Barrer. In some embodiments, the natural gas stream has a pressure of at least 500 psig and the H₂S has a permeability of about 400 to about 600 Barrer. In some embodiments, the natural gas stream has a pressure of at least 500 psig and the H₂S has a permeability of about 500 to about 600 Barrer.

In some embodiments, the natural gas stream has a pressure of at least 500 psig and the H₂S/CH₄ selectivity is about 20 to about 35, about 24 to about 32, about 26 to about 30, about 20 to about 32, about 20 to about 28, about 20 to about 24, about 24 to about 35, about 28 to about 35, or about 32 to about 35. In some embodiments, the natural gas stream has a pressure of at least 500 psig and the H₂S/CH₄ selectivity is about 20 to about 35. In some embodiments, the natural gas stream has a pressure of at least 500 psig and the H₂S/CH₄ selectivity is about 24 to about 32. In some embodiments, the natural gas stream has a pressure of at least 500 psig and the H₂S/CH₄ selectivity is about 26 to about 30. In some embodiments, the natural gas stream has a pressure of at least 500 psig and the H₂S/CH₄ selectivity is about 20 to about 32. In some embodiments, the natural gas stream has a pressure of at least 500 psig and the H₂S/CH₄ selectivity is about 20 to about 28. In some embodiments, the natural gas stream has a pressure of at least 500 psig and the H₂S/CH₄ selectivity is about 20 to about 24. In some embodiments, the natural gas stream has a pressure of at least 500 psig and the H₂S/CH₄ selectivity is about 24 to about 35. In some embodiments, the natural gas stream has a pressure of at least 500 psig and the H₂S/CH₄ selectivity is about 28 to about 35. In some embodiments, the natural gas stream has a pressure of at least 500 psig and the H₂S/CH₄ selectivity is about 32 to about 35.

In some embodiments, the natural gas stream has a pressure of at least 500 psig and the CO₂ has a permeability of about 100 to about 350 Barrer, about 120 to about 300 Barrer, about 140 to about 275 Barrer, about 160 to about 250 Barrer, about 180 to about 225 Barrer, about 190 to about 200 Barrer, about 100 to about 300 Barrer, about 100 to about 250 Barrer, about 100 to about 200 Barrer, about 100 to about 150 Barrer, about 150 to about 350 Barrer, about 200 to about 350 Barrer, about 250 to about 350 Barrer, or about 300 to about 350 Barrer. In some embodiments, the natural gas stream has a pressure of at least 500 psig and the CO₂ has a permeability of about 100 to about 350 Barrer. In some embodiments, the natural gas stream has a pressure of at least 500 psig and the CO₂ has a permeability of about 120 to about 300 Barrer. In some embodiments, the natural gas stream has a pressure of at least 500 psig and the CO₂ has a permeability of about 140 to about 275 Barrer. In some embodiments, the natural gas stream has a pressure of at least 500 psig and the CO₂ has a permeability of about 160 to about 250 Barrer. In some embodiments, the natural gas stream has a pressure of at least 500 psig and the CO₂ has a permeability of about 180 to about 225 Barrer. In some embodiments, the natural gas stream has a pressure of at least 500 psig and the CO₂ has a permeability of about 190 to about 200 Barrer. In some embodiments, the natural gas stream has a pressure of at least 500 psig and the CO₂ has a permeability of about 100 to about 300 Barrer. In some embodiments, the natural gas stream has a pressure of at least 500 psig and the CO₂ has a permeability of about 100 to about 250 Barrer. In some embodiments, the natural gas stream has a pressure of at least 500 psig and the CO₂ has a permeability of about 100 to about 200 Barrer. In some embodiments, the natural gas stream has a pressure of at least 500 psig and the CO₂ has a permeability of about 100 to about 150 Barrer. In some embodiments, the natural gas stream has a pressure of at least 500 psig and the CO₂ has a permeability of about 150 to about 350 Barrer. In some embodiments, the natural gas stream has a pressure of at least 500 psig and the CO₂ has a permeability of about 200 to about 350 Barrer. In some embodiments, the natural gas stream has a pressure of at least 500 psig and the CO₂ has a permeability of about 250 to about 350 Barrer. In some embodiments, the natural gas stream has a pressure of at least 500 psig and the CO₂ has a permeability of about 300 to about 350 Barrer.

In some embodiments, the natural gas stream has a pressure of at least 500 psig and the CO₂/CH₄ selectivity is about 15 to about 40, about 18 to about 36, about 22 to about 32, about 24 to about 30, about 26 to about 28, about 15 to about 36, about 15 to about 32, about 15 to about 28, about 15 to about 24, about 15 to about 20, about 18 to about 40, about 20 to about 40, about 24 to about 40, about 28 to about 40, about 32 to about 40, or about 36 to about 40. In some embodiments, the natural gas stream has a pressure of at least 500 psig and the CO₂/CH₄ selectivity is about 15 to about 40. In some embodiments, the natural gas stream has a pressure of at least 500 psig and the CO₂/CH₄ selectivity is about 18 to about 36. In some embodiments, the natural gas stream has a pressure of at least 500 psig and the CO₂/CH₄ selectivity is about 22 to about 32. In some embodiments, the natural gas stream has a pressure of at least 500 psig and the CO₂/CH₄ selectivity is about 24 to about 30. In some embodiments, the natural gas stream has a pressure of at least 500 psig and the CO₂/CH₄ selectivity is about 26 to about 28. In some embodiments, the natural gas stream has a pressure of at least 500 psig and the CO₂/CH₄ selectivity is about 15 to about 36. In some embodiments, the natural gas stream has a pressure of at least 500 psig and the CO₂/CH₄ selectivity is about 15 to about 32. In some embodiments, the natural gas stream has a pressure of at least 500 psig and the CO₂/CH₄ selectivity is about 15 to about 28. In some embodiments, the natural gas stream has a pressure of at least 500 psig and the CO₂/CH₄ selectivity is about 15 to about 24. In some embodiments, the natural gas stream has a pressure of at least 500 psig and the CO₂/CH₄ selectivity is about 15 to about 20. In some embodiments, the natural gas stream has a pressure of at least 500 psig and the CO₂/CH₄ selectivity is about 18 to about 40. In some embodiments, the natural gas stream has a pressure of at least 500 psig and the CO₂/CH₄ selectivity is about 20 to about 40. In some embodiments, the natural gas stream has a pressure of at least 500 psig and the CO₂/CH₄ selectivity is about 24 to about 40. In some embodiments, the natural gas stream has a pressure of at least 500 psig and the CO₂/CH₄ selectivity is about 28 to about 40. In some embodiments, the natural gas stream has a pressure of at least 500 psig and the CO₂/CH₄ selectivity is about 32 to about 40. In some embodiments, the natural gas stream has a pressure of at least 500 psig and the CO₂/CH₄ selectivity is about 36 to about 40.

In some embodiments:
(i) the H₂S has a permeability of about 75 to about 550 Barrer;
(ii) the H₂S/CH₄ selectivity is about 20 to about 35;
(iii) the CO₂ has a permeability is about 120 to about 300 Barrer; and/or
(iv) the CO₂/CH₄ selectivity is about 15 to about 40;
   where the natural gas stream has a pressure of at least 500 psig.

In some embodiments, the natural gas stream has a pressure of at least 500 psig and the CH₄ has a permeability of about 2 to about 20 Barrer, about 3 to about 16 Barrer, about 4 to about 12 Barrer, about 5 to about 10 Barrer, about 6 to about 8 Barrer, about 2 to about 16 Barrer, about 2 to about 12 Barrer, about 2 to about 8 Barrer, about 2 to about 4 Barrer, about 4 to about 20 Barrer, about 8 to about 20 Barrer, about 12 to about 20 Barrer, about 16 to about 20 Barrer. In some embodiments, the natural gas stream has a pressure of at least 500 psig and the CH₄ has a permeability of about 2 to about 20 Barrer. In some embodiments, the natural gas stream has a pressure of at least 500 psig and the CH₄ has a permeability of about 3 to about 16 Barrer. In some embodiments, the natural gas stream has a pressure of at least 500 psig and the CH₄ has a permeability of about 4 to about 12 Barrer. In some embodiments, the natural gas stream has a pressure of at least 500 psig and the CH₄ has a permeability of about 5 to about 10 Barrer. In some embodiments, the natural gas stream has a pressure of at least 500 psig and the CH₄ has a permeability of about 6 to about 8 Barrer. In some embodiments, the natural gas stream has a pressure of at least 500 psig and the CH₄ has a permeability of about 2 to about 16 Barrer. In some embodiments, the natural gas stream has a pressure of at least 500 psig and the CH₄ has a permeability of about 2 to about 12 Barrer. In some embodiments, the natural gas stream has a pressure of at least 500 psig and the CH₄ has a permeability of about 2 to about 8 Barrer. In some embodiments, the natural gas stream has a pressure of at least 500 psig and the CH₄ has a permeability of about 2 to about 4 Barrer. In some embodiments, the natural gas stream has a pressure of at least 500 psig and the CH₄ has a permeability of about 4 to about 20 Barrer. In some embodiments, the natural gas stream has a pressure of at least 500 psig and the CH₄ has a permeability of about 8 to about 20 Barrer. In some embodiments, the natural gas stream has a pressure of at least 500 psig and the CH₄ has a permeability of about 12 to about 20 Barrer. In some embodiments, the natural gas stream has a pressure of at least 500 psig and the CH₄ has a permeability of about 16 to about 20 Barrer.

In some embodiments, the natural gas stream has a pressure of at least 500 psig and the polymer membrane exhibits an H₂S permeability increase of about 65% to about 320% as compared to the same polymer membrane including a different polymer.

In some embodiments, the natural gas stream has a pressure of at least 500 psig and the polymer membrane exhibits a CO₂ permeability increase of about 150% to about 270% as compared to the same polymer membrane including a different polymer.

In some embodiments, the natural gas stream has a pressure of at least 500 psig and the polymer membrane exhibits:
(i) an H₂S permeability increase of about 65% to about 320%; and/or
(ii) a CO₂ permeability increase of about 150% to about 270%;
as compared to the same polymer membrane including a different polymer.

In some embodiments, the natural gas stream has a pressure of at least 500 psig and the polymer membrane exhibits an H₂S permeability increase of about 65% to about 320% as compared to the same polymer membrane including 6FDA-DAM/DABA (3:2) polymer.

In some embodiments, the natural gas stream has a pressure of at least 500 psig and the polymer membrane exhibits a CO₂ permeability increase of about 150% to about 270% as compared to the same polymer membrane including 6FDA-DAM/DABA (3:2) polymer.

In some embodiments, the natural gas stream has a pressure of at least 500 psig and the polymer membrane exhibits:
(i) an H₂S permeability increase of about 65% to about 320%; and/or
(ii) a CO₂ permeability increase of about 150% to about 270%;
as compared to the same polymer membrane including 6FDA-DAM/DABA (3:2) polymer.

In some embodiments, the natural gas stream has a pressure of at least 500 psig and the polymer membrane exhibits an H₂S/CH₄ selectivity increase of about 1% to about 15% as compared to the same polymer membrane including a different polymer.

In some embodiments, the natural gas stream has a pressure of at least 500 psig and the polymer membrane exhibits a CO₂/CH₄ selectivity increase of about 40% to about 60% as compared to the same polymer membrane including a different polymer.

In some embodiments, the natural gas stream has a pressure of at least 500 psig and the polymer membrane exhibits:
(i) an H₂S/CH₄ selectivity increase of about 1% to about 15%; and/or
(ii) a CO₂/CH₄ selectivity increase of about 40% to about 60%;
   as compared to the same polymer membrane including a different polymer.

In some embodiments, the natural gas stream has a pressure of at least 500 psig and the polymer membrane exhibits an H₂S/CH₄ selectivity increase of about 1% to about 15% as compared to the same polymer membrane including 6FDA-DAM polymer.

In some embodiments, the natural gas stream has a pressure of at least 500 psig and the polymer membrane exhibits a CO₂/CH₄ selectivity increase of about 40% to about 60% as compared to the same polymer membrane including 6FDA-DAM polymer.

In some embodiments, the natural gas stream has a pressure of at least 500 psig and the polymer membrane exhibits:
(i) an H₂S/CH₄ selectivity increase of about 1% to about 15%; and/or
(ii) a CO₂/CH₄ selectivity increase of about 40% to about 60%;
   as compared to the same polymer membrane including 6FDA-DAM polymer.

In some embodiments, the natural gas stream has a pressure of at least 800 psig and the H₂S has a permeability of about 50 to about 600 Barrer, about 75 to about 550 Barrer, about 100 to about 500 Barrer, about 150 to about 450 Barrer, about 200 to about 400 Barrer, about 250 to about 350 Barrer, about 50 to about 500 Barrer, about 50 to about 400 Barrer, about 50 to about 300 Barrer, about 50 to about 200 Barrer, about 50 to about 100 Barrer, about 100 to about 600 Barrer, about 200 to about 600 Barrer, about 300 to about 600 Barrer, about 400 to about 600 Barrer, or about 500 to about 600 Barrer. In some embodiments, the natural gas stream has a pressure of at least 800 psig and the H₂S has a permeability of about 50 to about 600 Barrer. In some embodiments, the natural gas stream has a pressure of at least 800 psig and the H₂S has a permeability of about 75 to about 550 Barrer. In some embodiments, the natural gas stream has a pressure of at least 800 psig and the H₂S has a permeability of about 100 to about 500 Barrer. In some embodiments, the natural gas stream has a pressure of at least 800 psig and the H₂S has a permeability of about 150 to about 450 Barrer. In some embodiments, the natural gas stream has a pressure of at least 800 psig and the H₂S has a permeability of about 200 to about 400 Barrer. In some embodiments, the natural gas stream has a pressure of at least 800 psig and the H₂S has a permeability of about 250 to about 350 Barrer. In some embodiments, the natural gas stream has a pressure of at least 800 psig and the H₂S has a permeability of about 50 to about 500 Barrer. In some embodiments, the natural gas stream has a pressure of at least 800 psig and the H₂S has a permeability of about 50 to about 400 Barrer. In some embodiments, the natural gas stream has a pressure of at least 800 psig and the H₂S has a permeability of about 50 to about 300 Barrer. In some embodiments, the natural gas stream has a pressure of at least 800 psig and the H₂S has a permeability of about 50 to about 200 Barrer. In some embodiments, the natural gas stream has a pressure of at least 800 psig and the H₂S has a permeability of about 50 to about 100 Barrer. In some embodiments, the natural gas stream has a pressure of at least 800 psig and the H₂S has a permeability of about 100 to about 600 Barrer. In some embodiments, the natural gas stream has a pressure of at least 800 psig and the H₂S has a permeability of about 200 to about 600 Barrer. In some embodiments, the natural gas stream has a pressure of at least 800 psig and the H₂S has a permeability of about 300 to about 600 Barrer. In some embodiments, the natural gas stream has a pressure of at least 800 psig and the H₂S has a permeability of about 400 to about 600 Barrer. In some embodiments, the natural gas stream has a pressure of at least 800 psig and the H₂S has a permeability of about 500 to about 600 Barrer.

In some embodiments, the natural gas stream has a pressure of at least 800 psig and the H₂S/CH₄ selectivity is about 15 to about 40, about 18 to about 36, about 20 to about 32, about 24 to about 28, about 15 to about 36, about 15 to about 32, about 15 to about 28, about 15 to about 24, about 15 to about 20, about 20 to about 40, about 24 to about 40, about 28 to about 40, about 32 to about 40, or about 36 to about 40. In some embodiments, the natural gas stream has a pressure of at least 800 psig and the H₂S/CH₄ selectivity is about 15 to about 40. In some embodiments, the natural gas stream has a pressure of at least 800 psig and the H₂S/CH₄ selectivity is about 18 to about 36. In some embodiments, the natural gas stream has a pressure of at least 800 psig and the H₂S/CH₄ selectivity is about 20 to about 32. In some embodiments, the natural gas stream has a pressure of at least 800 psig and the H₂S/CH₄ selectivity is about 24 to about 28. In some embodiments, the natural gas stream has a pressure of at least 800 psig and the H₂S/CH₄ selectivity is about 15 to about 36. In some embodiments, the natural gas stream has a pressure of at least 800 psig and the H₂S/CH₄ selectivity is about 15 to about 32. In some embodiments, the natural gas stream has a pressure of at least 800 psig and the H₂S/CH₄ selectivity is about 15 to about 28. In some embodiments, the natural gas stream has a pressure of at least 800 psig and the H₂S/CH₄ selectivity is about 15 to about 24. In some embodiments, the natural gas stream has a pressure of at least 800 psig and the H₂S/CH₄ selectivity is about 15 to about 20. In some embodiments, the natural gas stream has a pressure of at least 800 psig and the H₂S/CH₄ selectivity is about 20 to about 40. In some embodiments, the natural gas stream has a pressure of at least 800 psig and the H₂S/CH₄ selectivity is about 24 to about 40. In some embodiments, the natural gas stream has a pressure of at least 800 psig and the H₂S/CH₄ selectivity is about 28 to about 40. In some embodiments, the natural gas stream has a pressure of at least 800 psig and the H₂S/CH₄ selectivity is about 32 to about 4. In some embodiments, the natural gas stream has a pressure of at least 800 psig and the H₂S/CH₄ selectivity is about 36 to about 40.

In some embodiments, the natural gas stream has a pressure of at least 800 psig and the CO₂ has a permeability of about 50 to about 350 Barrer, about 75 to about 300 Barrer, about 100 to about 250 Barrer, about 150 to about 200 Barrer, about 50 to about 300 Barrer, about 50 to about 200 Barrer, about 50 to about 100 Barrer, about 100 to about 350 Barrer, about 200 to about 350 Barrer, or about 300 to about 350 Barrer. In some embodiments, the natural gas stream has a pressure of at least 800 psig and the CO₂ has a permeability of about 50 to about 350 Barrer. In some embodiments, the natural gas stream has a pressure of at least 800 psig and the CO₂ has a permeability of about 75 to about 300 Barrer. In some embodiments, the natural gas stream has a pressure of at least 800 psig and the CO₂ has a permeability of about 100 to about 250 Barrer. In some embodiments, the natural gas stream has a pressure of at least 800 psig and the CO₂ has a permeability of about 150 to about 200 Barrer. In some embodiments, the natural gas stream has a pressure of at least 800 psig and the CO₂ has a permeability of about 50 to about 300 Barrer. In some embodiments, the natural gas stream has a pressure of at least 800 psig and the CO₂ has a permeability of about 50 to about 200 Barrer. In some embodiments, the natural gas stream has a pressure of at least 800 psig and the CO₂ has a permeability of about 50 to about 100 Barrer. In some embodiments, the natural gas stream has a pressure of at least 800 psig and the CO₂ has a permeability of about 100 to about 350 Barrer. In some embodiments, the natural gas stream has a pressure of at least 800 psig and the CO₂ has a permeability of about 200 to about 350 Barrer. In some embodiments, the natural gas stream has a pressure of at least 800 psig and the CO₂ has a permeability of about 300 to about 350 Barrer.

In some embodiments, the natural gas stream has a pressure of at least 800 psig and the CO₂/CH₄ selectivity is about 15 to about 35, about 18 to about 32, about 20 to about 30, about 24 to about 26, about 15 to about 30, about 15 to about 25, about 15 to about 20, about 20 to about 35, about 25 to about 35, or about 30 to about 35. In some embodiments, the natural gas stream has a pressure of at least 800 psig and the CO₂/CH₄ selectivity is about 15 to about 35. In some embodiments, the natural gas stream has a pressure of at least 800 psig and the CO₂/CH₄ selectivity is about 18 to about 32. In some embodiments, the natural gas stream has a pressure of at least 800 psig and the CO₂/CH₄ selectivity is about 20 to about 30. In some embodiments, the natural gas stream has a pressure of at least 800 psig and the CO₂/CH₄ selectivity is about 24 to about 26. In some embodiments, the natural gas stream has a pressure of at least 800 psig and the CO₂/CH₄ selectivity is about 15 to about 30. In some embodiments, the natural gas stream has a pressure of at least 800 psig and the CO₂/CH₄ selectivity is about 15 to about 25. In some embodiments, the natural gas stream has a pressure of at least 800 psig and the CO₂/CH₄ selectivity is about 15 to about 20. In some embodiments, the natural gas stream has a pressure of at least 800 psig and the CO₂/CH₄ selectivity is about 20 to about 35. In some embodiments, the natural gas stream has a pressure of at least 800 psig and the CO₂/CH₄ selectivity is about 25 to about 35. In some embodiments, the natural gas stream has a pressure of at least 800 psig and the CO₂/CH₄ selectivity is about 30 to about 35.

In some embodiments:
(i) the H₂S has a permeability of 50 to about 600 Barrer;
(ii) the H₂S/CH₄ selectivity is about 15 to about 40;
(iii) the CO₂ has a permeability is about 50 to about 350 Barrer; and/or
(iv) the CO₂/CH₄ selectivity is about 15 to about 35;
   where the natural gas stream has a pressure of at least 800 psig.

In some embodiments, the natural gas stream has a pressure of at least 800 psig and the CH₄ has a permeability of 1 to about 20 Barrer, about 2 to about 16 Barrer, about 4 to about 12 Barrer, about 6 to about 10 Barrer, about 1 to about 16 Barrer, about 1 to about 12 Barrer, about 1 to about 8 Barrer, about 1 to about 4 Barrer, about 2 to about 20 Barrer, about 4 to about 20 Barrer, about 8 to about 20 Barrer, about 12 to about 20 Barrer, or about 16 to about 20 Barrer. In some embodiments, the natural gas stream has a pressure of at least 800 psig and the CH₄ has a permeability of 1 to about 20 Barrer. In some embodiments, the natural gas stream has a pressure of at least 800 psig and the CH₄ has a permeability of about 2 to about 16 Barrer. In some embodiments, the natural gas stream has a pressure of at least 800 psig and the CH₄ has a permeability of about 4 to about 12 Barrer. In some embodiments, the natural gas stream has a pressure of at least 800 psig and the CH₄ has a permeability of about 6 to about 10 Barrer. In some embodiments, the natural gas stream has a pressure of at least 800 psig and the CH₄ has a permeability of about 1 to about 16 Barrer. In some embodiments, the natural gas stream has a pressure of at least 800 psig and the CH₄ has a permeability of about 1 to about 12 Barrer. In some embodiments, the natural gas stream has a pressure of at least 800 psig and the CH₄ has a permeability of about 1 to about 8 Barrer. In some embodiments, the natural gas stream has a pressure of at least 800 psig and the CH₄ has a permeability of about 1 to about 4 Barrer. In some embodiments, the natural gas stream has a pressure of at least 800 psig and the CH₄ has a permeability of about 2 to about 20 Barrer. In some embodiments, the natural gas stream has a pressure of at least 800 psig and the CH₄ has a permeability of about 4 to about 20 Barrer. In some embodiments, the natural gas stream has a pressure of at least 800 psig and the CH₄ has a permeability of about 8 to about 20 Barrer. In some embodiments, the natural gas stream has a pressure of at least 800 psig and the CH₄ has a permeability of about 12 to about 20 Barrer. In some embodiments, the natural gas stream has a pressure of at least 800 psig and the CH₄ has a permeability of about 16 to about 20 Barrer.

In some embodiments, the natural gas stream has a pressure of at least 800 psig and the polymer membrane exhibits an H₂S permeability increase of about 190% to about 320% as compared to the same polymer membrane including a different polymer.

In some embodiments, the natural gas stream has a pressure of at least 800 psig and the polymer membrane exhibits an H₂S/CH₄ selectivity increase of up to about 30% as compared to the same polymer membrane including a different polymer.

In some embodiments, the natural gas stream has a pressure of at least 800 psig and the polymer membrane exhibits a CO₂ permeability increase of about 50% to about 220% as compared to the same polymer membrane including a different polymer.

In some embodiments, the natural gas stream has a pressure of at least 800 psig and the polymer membrane exhibits a CO₂/CH₄ selectivity increase of up to about 5% as compared to the same polymer membrane including a different polymer.

In some embodiments, the natural gas stream has a pressure of at least 800 psig and the polymer membrane exhibits:
(i) an H₂S permeability increase of about 190% to about 320%;
(ii) an H₂S/CH₄ selectivity increase of up to about 30%;
(ii) a CO₂ permeability increase of about 50% to about 220%; and/or
(iv) a CO₂/CH₄ selectivity increase of up to about 5%;
   as compared to the same polymer membrane including a different polymer.

In some embodiments, the natural gas stream has a pressure of at least 800 psig and the polymer membrane exhibits an H₂S permeability increase of about 190% to about 320% as compared to the same polymer membrane including 6FDA-DAM/DABA (3:2) polymer.

In some embodiments, the natural gas stream has a pressure of at least 800 psig and the polymer membrane exhibits an H₂S/CH₄ selectivity increase of up to about 30% as compared to the same polymer membrane including 6FDA-DAM/DABA (3:2) polymer.

In some embodiments, the natural gas stream has a pressure of at least 800 psig and the polymer membrane exhibits a CO₂ permeability increase of about 50% to about 220% as compared to the same polymer membrane including 6FDA-DAM/DABA (3:2) polymer.

In some embodiments, the natural gas stream has a pressure of at least 800 psig and the polymer membrane exhibits a CO₂/CH₄ selectivity increase of up to about 5% as compared to the same polymer membrane including 6FDA-DAM/DABA (3:2) polymer.

In some embodiments, the natural gas stream has a pressure of at least 800 psig and the polymer membrane exhibits:
(i) an H₂S permeability increase of about 190% to about 320%;
(ii) an H₂S/CH₄ selectivity increase of up to about 30%;
(ii) a CO₂ permeability increase of about 50% to about 220%; and/or
(iv) a CO₂/CH₄ selectivity increase of up to about 5%;
   as compared to the same polymer membrane including 6FDA-DAM/DABA (3:2) polymer.

In some embodiments, the natural gas stream has a pressure of at least 800 psig and the polymer membrane exhibits a CO₂/CH₄ selectivity increase of about 40% to about 60% as compared to the same polymer membrane including a different polymer.

In some embodiments, the natural gas stream has a pressure of at least 800 psig and the polymer membrane exhibits a CO₂/CH₄ selectivity increase of about 40% to about 60% as compared to the same polymer membrane including 6FDA-DAM polymer.

In some embodiments, the C₂H₆ has a permeability of about 2 to about 30 Barrer, about 5 to about 25 Barrer, or about 10 to about 20 Barrer. In some embodiments, the C₂H₆ has a permeability of about 2 to about 30 Barrer. In some embodiments, the C₂H₆ has a permeability of about 5 to about 25 Barrer. In some embodiments, the C₂H₆ has a permeability of about 10 to about 20 Barrer.

In some embodiments, the N₂ has a permeability of about 2 to about 15 Barrer, about 4 to about 12 Barrer, or about 5 to about 10 Barrer. In some embodiments, the N₂ has a permeability of about 2 to about 15 Barrer. In some embodiments, the N₂ has a permeability of about 4 to about 12 Barrer. In some embodiments, the N₂ has a permeability of about 5 to about 10 Barrer.

In some embodiments, the polymer membrane exhibits a CO₂/N₂ selectivity of about 15 to about 30, about 18 to about 28, or about 20 to about 25.

In some embodiments, the polymer membrane exhibits a CO₂/N₂ selectivity of about 15 to about 30. In some embodiments, the polymer membrane exhibits a CO₂/N₂ selectivity of about 18 to about 28. In some embodiments, the polymer membrane exhibits a CO₂/N₂ selectivity of about 20 to about 25.

In some embodiments, the polymer membrane exhibits a H₂S/N₂ selectivity of about 25 to about 50, about 30 to about 45, about 35 to about 40.

In some embodiments, the polymer membrane exhibits a H₂S/N₂ selectivity of about 25 to about 50. In some embodiments, the polymer membrane exhibits a H₂S/N₂ selectivity of about 30 to about 45. In some embodiments, the polymer membrane exhibits a H₂S/N₂ selectivity of about 35 to about 40.

### EXAMPLES

### Example 1. Synthesis of the Polymer Membranes

The 6FDA-diaminomesitylene (DAM)/3,5-diaminobenzoic acid (DABA) polyimide polymers were purchased from Akron Polymer System Inc.

The polymers were pre-dried in a vacuum oven at 100° C. overnight. The 6FDA-DAM/DABA polyimide membranes were prepared by dissolving each of 6FDA-DAM/DABA (3:2), 6FDA-DAM/DABA (3:1), and 6FDA-DAM/DABA (5:1) in THE to form about 5 wt % polyimide/THF mixtures. The polyimide/THF mixtures were further mixed on rolling mixers overnight to dissolve the polymers. The resulting solutions were poured onto polytetrafluoroethylene (PTFE) evaporating dishes in glove bags pre-saturated with THE vapor, and the solutions were allowed at least 4 h slow evaporation to create 70-90 m films. The films were left overnight and thermally treated under vacuum oven at 200° C. for 24 h to remove remaining solvent and thermally treat the films.

The membranes were characterized using a constant-volume apparatus at 25° C. and 800 psig. These conditions were selected because they simulate realistic conditions of natural gas processing. Two different mixtures simulating sour natural gas were evaluated in the permeability and selectivity measurements: 5% H₂S, 3% CO₂, and 92% CH₄, and 20% H₂S, 10% CO₂, 57% CH₄, 3% C₂H₆, and 10% N₂ by volume. The downstream compositions were determined using a gas chromatograph (Schimadzu GC-2014). The stage cut (the flow rate ratio of permeate to feed) was maintained below 1%. All of the results were collected at the steady state.

### Example 2. Characterization of Gas Separation Properties of Polymer Membranes of Ternary Gas Mixture Containing H₂S, CO₂, and CH₄

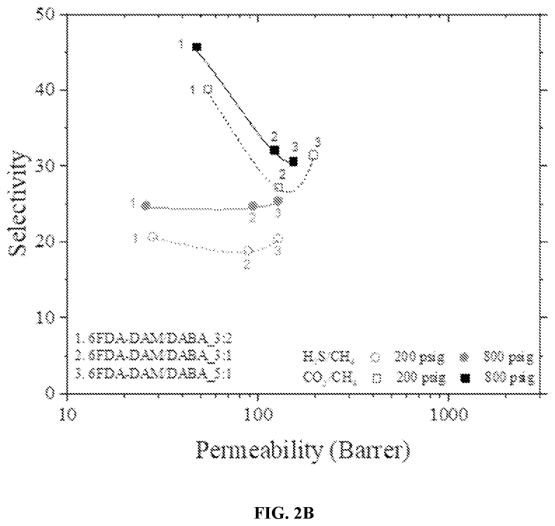

The permeation results of the polyimide membranes were evaluated on gas mixtures containing 5% H₂S, 3% CO₂, and 92% CH₄ by volume at 25° C. and at 200, 500, and 800 psig. The results for each membrane and each pressure are shown in Table 1, FIG. 2A, and FIG. 2B.

TABLE 1
Ternary mixed gas permeation results of 6FDA-DAM/DABA polyimide
membranes at 25° C. and 200, 500, and 800 psig.

| | Pressure | Permeability (Barrer) | | | Selectivity | |
|---|---|---|---|---|---|---|
| Membrane | (psig) | H₂S | CO₂ | CH₄ | H₂S/CH₄ | CO₂/CH₄ |
| 6FDA-DAM/DABA (3:2) | 200 | 36.1 | 97.9 | 2.1 | 16.93 | 45.93 |
| | 500 | 30.8 | 75.8 | 1.7 | 17.76 | 43.77 |
| | 800 | 31.8 | 75.6 | 1.6 | 19.66 | 46.71 |
| 6FDA-DAM/DABA (3:1) | 200 | 88.5 | 127.9 | 4.7 | 18.83 | 27.21 |
| | 500 | 92.5 | 143.9 | 4.1 | 22.56 | 35.10 |
| | 800 | 94 | 122 | 3.8 | 24.74 | 32.11 |
| 6FDA-DAM/DABA (5:1) | 200 | 127.0 | 194.9 | 6.2 | 20.48 | 31.44 |
| | 500 | 124.9 | 173.0 | 5.4 | 23.28 | 32.30 |
| | 800 | 127.1 | 153.2 | 5.0 | 25.42 | 30.64 |

As shown in FIG. 2A and Table 1, increasing the DAM/DABA ratio (which decreases the DABA or —COOH group content) from (3:2) to (5:1) resulted in an increase of gas permeabilities. Particularly, the H₂S permeability increased by about 4 fold and the CO₂ permeability increased by about 2 fold. The H₂S/CH₄ selectivity increased from 19.66 to 25.42 (about 30%), while the CO₂/CH₄ selectivity decreased from about 46.71 to 30.64 (about 35%).

As shown in FIG. 2B, the permeation results of the polyimide membranes were generally increased when the total feed pressure was increased from 200 to 800 psig. Without wishing to be bound by theory, this is believed to be due to higher partial gas pressures resulting in higher condensability of H₂S for the 6FDA-DAM/DABA polyimide membranes.

Overall, the results for the for the ternary gas mixture containing 5% H₂S, 3% CO₂, and 92% CH₄ demonstrate that both H₂S and CO₂ separation performance is affected by varying the DABA content of the 6FDA-DAM/DABA type polyimides. The 6FDA-DAM/DABA polyimide membranes evaluated outperformed the commercial membranes for both H₂S/CH₄ and CO₂/CH₄ separations for the ternary gas mixture containing 5% H₂S, 3% CO₂, and 92% CH₄ by volume at 25° C. and at 200, 500, and 800 psig. Moreover, both the H₂S/CH₄ and CO₂/CH₄ separation efficiencies were adjusted by variation of the DAM/DABA ratio. Particularly, the 6FDA-DAM/DABA (5:1) polyimide membrane showed improved H₂S permeability and H₂S/CH₄ selectivities than 6FDA-DAM/DABA (3:2) and 6FDA-DAM/DABA (3:1). The CO₂ permeability and CO₂/CH₄ selectivities were comparable for all three polymers.

### Example 3. Characterization of Gas Separation Properties of Polymer Membranes of Ternary Gas Mixture Containing H₂S, CO₂, CH₄, C₂H₆, and N₂

To further evaluate the gas concentration effect on membrane performance, the 6FDA-DAM/DABA polyimide membranes were measured under higher sour gas feed streams containing 20% H₂S, 10% CO₂, 57% CH₄, 3% C₂H₆, and 10% N₂ by at 25° C. and 200, 500, and 800 psig. Compared to the ternary gas mixture evaluated in Example 2, these conditions are more corrosive due to the increased concentration of condensable gases (e.g., increasing the H₂S concentration from 5% to 20% and the CO₂ concentration from 3% 10%) and the presence of C₂₊ hydrocarbons (e.g. 3% C₂H₆). 6FDA-DAM polyimide membranes were also measured at the same conditions for comparison.

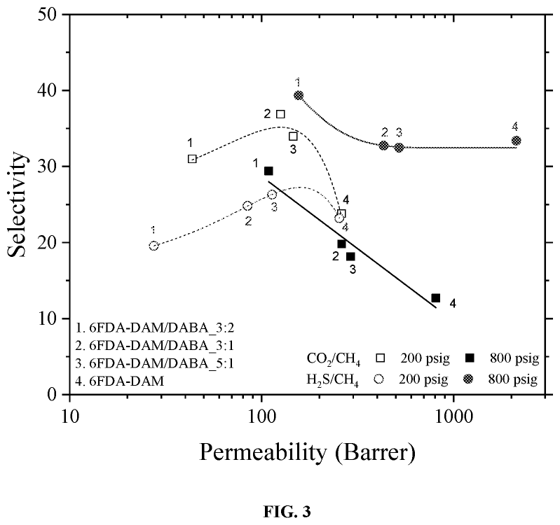

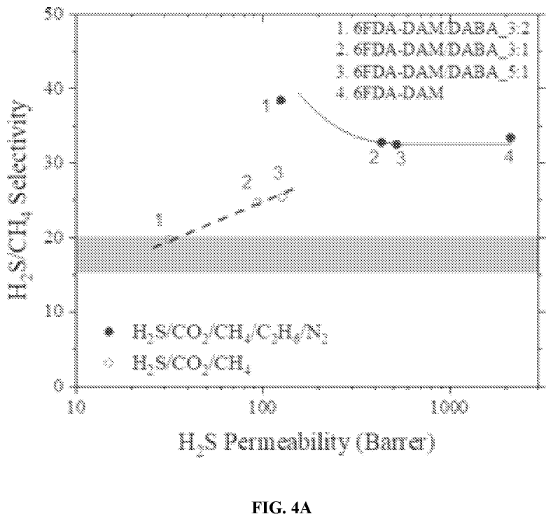

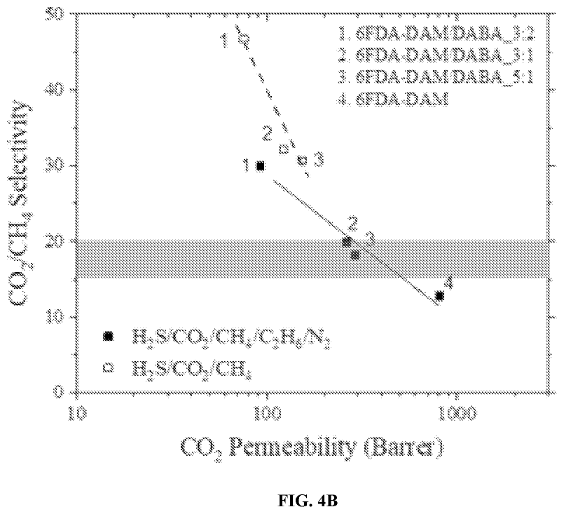

The permeation results of the polyimide membranes were evaluated on gas mixtures containing 20% H₂S, 10% CO₂, 57% CH₄, 3% C₂H₆, and 10% N₂ by volume at 25° C. and at 200, 500, and 800 psig are shown in Table 2, FIG. 3, FIG. 4A, and FIG. 4B.

TABLE 2
Mixed gas permeation results of 6FDA-DAM/DABA polyimide
membranes at 25° C. and 200, 500, and 800 psig.

| | | | | | | | Selectivity | | | |
|---|---|---|---|---|---|---|---|---|---|---|
| | Pressure | Permeability (Barrer) | | | | | H₂S/ | CO₂/ | | |
| Membrane | (psig) | H₂S | CO₂ | CH₄ | C₂H₆ | N₂ | CH₄ | CH₄ | CO₂/N₂ | H₂S/N₂ |
| 6FDA- | 200 | 31.2 | 40.1 | 1.29 | 0.37 | 7.9 | 21.2 | 33.6 | 12.2 | 3.9 |
| DAM/ | 500 | 49.4 | 57.2 | 1.70 | 1.07 | 2.4 | 29.3 | 34.0 | 24.2 | 20.6 |
| DABA | 800 | 125.0 | 92.4 | 3.23 | 4.10 | 4.0 | 38.4 | 28.6 | 24.2 | 31.3 |
| (3:2) | | | | | | | | | | |
| 6FDA- | 200 | 84.4 | 125.4 | 3.40 | 5.70 | 3.1 | 24.8 | 36.9 | 40.45 | 27.2 |
| DAM/ | 500 | 132.6 | 145.3 | 5.00 | 5.50 | 4.7 | 29.1 | 26.5 | 28.21 | 28.2 |
| DABA | 800 | 432.3 | 261.5 | 13.2 | 20.50 | 12.3 | 32.8 | 19.8 | 21.26 | 35.1 |
| (3:1) | | | | | | | | | | |
| 6FDA- | 200 | 113.1 | 146.0 | 4.30 | 3.80 | 7.8 | 26.3 | 34.0 | 18.72 | 14.5 |
| DAM/ | 500 | 204.1 | 164.4 | 6.90 | 8.40 | 7.1 | 29.6 | 23.8 | 23.15 | 28.7 |
| DABA | 800 | 519.4 | 290.6 | 16.0 | 26.3 | 11.5 | 32.5 | 18.2 | 25.27 | 45.2 |
| (5:1) | | | | | | | | | | |
| 6FDA- | 200 | 254.1 | 260.4 | 11.0 | 9.90 | 82.9 | 23.2 | 23.8 | 2.29 | 3.1 |
| DAM | 500 | 598.1 | 341.1 | 20.8 | 28.75 | 30.2 | 28.9 | 16.5 | 14.3 | 19.8 |
| | 800 | 2101.9 | 815.2 | 63.0 | 142.6 | 66.3 | 33.4 | 12.9 | 9.6 | 31.7 |

As shown in Table 2 and FIG. 3, decreasing the DABA content in the 6FDA-DAM/DABA polyimide affects both H₂S/CH₄ and CO₂/CH₄ separation performances. The membranes containing less DABA, 6FDA-DAM/DABA (3:1) and 6FDA-DAM/DABA (5:1), exhibited higher gas permeabilities, while the 6FDA-DAM polyimide membrane exhibited the highest gas permeability. Compared to the 6FDA-DAM/DABA (3:2) polyimide membrane, 6FDA-DAM membrane showed about a 16.8 fold increase in H₂S permeability, about an 8.8 fold increase in CO₂ permeability, and about a 19.5 fold increase in CH₄ permeability. However, the CO₂/CH₄ selectivity of the 6FDA-DAM membrane decreased by about 13 fold. Without wishing to be bound by theory, this is believed to be due to the high relaxation of polymer chains under the higher H₂S concentrations evaluated here.

The 6FDA-DAM/DABA membranes, particularly 6FDA-DAM/DABA (3:2), did not exhibit as large decreases in CO₂/CH₄ selectivity as 6FDA-DAM. Without wishing to be bound by theory, it is believed that the introduction of the DABA group leads to increased passage of CH₄. As shown in Table 2, the CH₄ permeability of the 6FDA-DAM membrane increased by about 6 fold (e.g., from about 11.0 Barrer to about 63.0 Barrer) when the pressure was increase from 200 psig to 800 psig. For comparison, the CH₄ permeability increased by only about 2.5 fold for the 6FDA-DAM/DABA (3:2) membrane when increasing the pressure from 200 to 800 psig.

As shown in FIG. 4A and FIG. 4B, the gas composition affected the membrane performance. As shown in Example 2, the membranes were more CO₂ selective than H₂S selective when applied to the ternary gas mixture containing 5% H₂S, 3% CO₂, and 92% CH₄ by volume. However, the membranes were more selective when applied to the 20% H₂S, 10% CO₂, 57% CH₄, 3% C₂H₆, and 10% N₂ gas mixtures, which contained higher concentrations of both H₂S and CO₂. Without wishing to be bound by theory, this may be attributed to the H₂S-polymer chain interactions promoting higher relaxations of the polymer chains, which increases the free volume of the chains promoting higher diffusivity and H₂S condensability.

The 6FDA-DAM/DABA polyimide membranes increased CO₂/CH₄ selectivities but decreased CO₂ permeabilities. Increasing the DABA content led to a larger increase in the CO₂/CH₄ selectivity than the H₂S/CH₄ selectivity. For instance, compared to the 6FDA-DAM/DABA (5:1) polyimide membrane, the 6FDA-DAM/DABA (3:2) membrane exhibited about a 1.6 fold increase of the CO₂/CH₄ selectivity and about a 1.18 fold increase of the H₂S/CH₄ selectivity, but only about a 0.32 fold increase of the CO₂ permeability and about a 0.24 fold increase of the H₂S permeability. In this regard, the 6FDA-DAM/DABA (3:1) and 6FDA-DAM/DABA (5:1) polyimide membranes can better balance the H₂S/CH₄ and CO₂/CH₄ separations in terms of both permeability and selectivity, compared to both 6FDA-DAM and 6FDA-DAM/DABA (3:2). Furthermore, the 6FDA-DAM/DABA (3:1) and 6FDA-DAM/DABA (5:1) membranes showed comparable separation performances for both H₂S/CH₄ and CO₂/CH₄ separations. The 6FDA-DAM/DABA (3:2) membrane, containing a higher ratio of DABA, exhibiting a CO₂/CH₄ selectivity of about 28.61 and a H₂S/CH₄ selectivity of about 38.44, can be utilized for high H₂S and CO₂ content effective sour gas separation.

Overall, variation of DAM:DABA in 6FDA-DAM/DABA (e.g., varying —COOH groups) in the membrane polymer matrices aided condensability (solubility) control of H₂S and CO₂, which resulted in increased H₂S/CH₄ and CO₂/CH₄ mixed gas selectivities and controlled H₂S and CO₂ permeabilities. The disclosed membranes displayed increased CO₂/CH₄ and H₂S/CH₄ mixed gas selectivities and increased CO₂ and H₂S permeabilities for under higher concentrations of acid gas (e.g., 20% H₂S and 10% CO₂).

In case of lower H₂S content in the mixed gas (e.g 5% H₂S, 3% CO₂, and 92% CH₄), the disclosed membranes demonstrated that both H₂S/CH₄ and CO₂/CH₄ separation performance can be adjusted by tuning the DABA content of the 6FDA-DAM/DABA type polyimides. The inclusion of DABA in the 6FDA-DAM/DABA type polyimides suppresses the gas permeability of the hydrocarbon components at 200 psig to 800 psig, which demonstrates that DABA selectively promotes the separation of CO₂ and H₂S from the mixed acid gas compositions.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A method of separating carbon dioxide (CO₂) and hydrogen sulfide (H₂S) from natural gas, comprising:
providing a polymer membrane comprising a polymer selected from 6FDA-DAM/DABA (3:1) and 6FDA-DAM/DABA (5:1);
introducing a natural gas stream to the polymer membrane, wherein the natural gas stream comprises CO₂, H₂S, and methane (CH₄), and the natural gas stream comprises at least about 5% H₂S by volume; and
removing carbon dioxide (CO₂) and hydrogen sulfide (H₂S) from the natural gas.

2. The method of claim 1, wherein the natural gas stream comprises about 5% to about 30% H₂S by volume, about 5% to about 25% H₂S by volume, about 5% to about 20% H₂S by volume, about 5% to about 18% H₂S by volume, about 5% to about 16% H₂S by volume, about 5% to about 14% H₂S by volume, about 5% to about 12% H₂S by volume, about 5% to about 10% H₂S by volume, about 10% to about 20% H₂S by volume, about 12% to about 20% H₂S by volume, about 14% to about 20% H₂S by volume, about 16% to about 20% H₂S by volume, about 18% to about 20% H₂S by volume, or about 18% to about 22% H₂S by volume.

3. The method of claim 1, wherein the natural gas stream comprises about 20% or more H₂S by volume.

4. The method of claim 1, wherein the natural gas stream comprises about 5% to about 20% H₂S and about 3% to about 15% CO₂ by volume.

5. The method of claim 1, wherein the natural gas stream further comprises ethane (C₂H₆), ethylene (C₂H₄), C₃₊ hydrocarbons, nitrogen (N₂), water (H₂O), and combinations thereof.

6. The method of claim 1, wherein the natural gas stream has a pressure of at least about 800 psig.

7. The method of claim 1, wherein the polymer membrane is thermally treated.

8. The method of claim 1, wherein:
(i) the H₂S has a permeability of about 85 to about 135 Barrer;
(ii) the H₂S/CH₄ selectivity is about 15 to about 27;
(iii) the CO₂ has a permeability of about 120 to about 200 Barrer; and/or
(iv) the CO₂/CH₄ selectivity is about 24 to about 36.

9. The method of claim 1, wherein the polymer membrane exhibits:
(i) an H₂S permeability increase of about 140% to about 310%;
(ii) an H₂S/CH₄ selectivity increase of about 10% to about 35%; and/or
(iii) a CO₂ permeability increase of about 30% to about 230%;
as compared to the same polymer membrane comprising 6FDA-DAM/DABA (3:2) polymer.

10. The method of claim 1, wherein:
(i) the H₂S has a permeability of about 75 to about 550 Barrer;
(ii) the H₂S/CH₄ selectivity is about 20 to about 35;
(iii) the CO₂ has a permeability is about 120 to about 300 Barrer; and/or
(iv) the CO₂/CH₄ selectivity is about 15 to about 40;
wherein the natural gas stream comprises at least about 20% H₂S by volume.

11. The method of claim 1, wherein the natural gas stream comprises at least about 20% H₂S by volume and the polymer membrane exhibits:
(i) an H₂S permeability increase of about 65% to about 320%; and/or
(ii) a CO₂ permeability increase of about 150% to about 270%;
as compared to the same polymer membrane comprising 6FDA-DAM/DABA (3:2) polymer.

12. The method of claim 1, wherein the natural gas stream comprises at least about 20% H₂S by volume and the polymer membrane exhibits:
(i) an H₂S/CH₄ selectivity increase of about 1% to about 15%; and/or
(ii) a CO₂/CH₄ selectivity increase of about 40% to about 60%;
as compared to the same polymer membrane comprising 6FDA-DAM polymer.

13. A method of separating carbon dioxide (CO₂) and hydrogen sulfide (H₂S) from natural gas, comprising:
providing a polymer membrane comprising a polymer selected from 6FDA-DAM/DABA (3:1) and 6FDA-DAM/DABA (5:1);
introducing a natural gas stream to the polymer membrane, wherein the natural gas stream has a pressure of at least 500 psig; and
removing carbon dioxide (CO₂) and hydrogen sulfide (H₂S) from the natural gas.

14. The method of claim 13, wherein the natural gas stream has a pressure of about 500 psig to about 1100 psig, about 600 psig to about 1000 psig, about 700 psig to about 900 psig, or about 750 psig to about 850 psig.

15. The method of claim 13, wherein the natural gas stream has a pressure of at least about 800 psig.

16. The method of claim 13, wherein the natural gas stream comprises about 5% to about 30% H₂S by volume, about 5% to about 25% H₂S by volume, about 5% to about 20% H₂S by volume, about 5% to about 18% H₂S by volume, about 5% to about 16% H₂S by volume, about 5% to about 14% H₂S by volume, about 5% to about 12% H₂S by volume, about 5% to about 10% H₂S by volume, about 10% to about 20% H₂S by volume, about 12% to about 20% H₂S by volume, about 14% to about 20% H₂S by volume, about 16% to about 20% H₂S by volume, about 18% to about 20% H₂S by volume, or about 18% to about 22% H₂S by volume.

17. The method of claim 13, wherein the natural gas stream comprises about 20% or more H₂S by volume.

18. The method of claim 13, wherein the natural gas stream comprises about 5% to about 20% H₂S and about 3% to about 15% CO₂ by volume.

19. The method of claim 13, wherein the natural gas stream further comprises ethane (C₂H₆), ethylene (C₂H₄), C₃₊ hydrocarbons, nitrogen (N₂), water (H₂O), and combinations thereof.

20. The method of claim 13, wherein the polymer membrane is thermally treated.

21. The method of claim 13, wherein:
(i) the H₂S has a permeability of about 85 to about 135 Barrer;
(ii) the H₂S/CH₄ selectivity is about 15 to about 27;
(iii) the CO₂ has a permeability of about 120 to about 200 Barrer; and/or
(iv) the CO₂/CH₄ selectivity is about 24 to about 36.

22. The method of claim 13, wherein the polymer membrane exhibits:
(i) an H₂S permeability increase of about 140% to about 310%;
(ii) an H₂S/CH₄ selectivity increase of about 10% to about 35%; and/or
(iii) a CO₂ permeability increase of about 30% to about 230%;
as compared to the same polymer membrane comprising 6FDA-DAM/DABA (3:2) polymer.

23. The method of claim 13, wherein:
(i) the H₂S has a permeability of about 75 to about 550 Barrer;
(ii) the H₂S/CH₄ selectivity is about 20 to about 35;
(iii) the CO₂ has a permeability is about 120 to about 300 Barrer; and/or
(iv) the CO₂/CH₄ selectivity is about 15 to about 40;
wherein the natural gas stream has a pressure of at least 500 psig.

24. The method of claim 13, wherein the natural gas stream has a pressure of at least 500 psig and the polymer membrane exhibits:
(i) an H₂S permeability increase of about 65% to about 320%; and/or
(ii) a CO₂ permeability increase of about 150% to about 270%;
as compared to the same polymer membrane comprising 6FDA-DAM/DABA (3:2) polymer.

25. The method of claim 13, wherein the natural gas stream has a pressure of at least 500 psig and the polymer membrane exhibits:
(i) an H₂S/CH₄ selectivity increase of about 1% to about 15%; and/or
(ii) a CO₂/CH₄ selectivity increase of about 40% to about 60%;
as compared to the same polymer membrane comprising 6FDA-DAM polymer.

26. A method of preparing a polymer membrane, comprising:
providing a polymer solution comprising a solvent and a polymer, wherein the polymer is selected from 6FDA-DAM/DABA (3:1) and 6FDA-DAM/DABA (5:1);
evaporating the solvent to form a polymer membrane film; and
thermally treating the polymer membrane film to form the polymer membrane.

27. The method of claim 26, wherein thermally treating the polymer membrane film comprises heating the polymer membrane film to about 200° C. for about 24 hours.
